(19) United States
(12) Patent Application Publication
(10) Pub. No.: US 2026/0301617 A1
(43) Pub. Date: Oct. 1, 2026

(54) INFORMATION PROJECTION APPARATUS

(71) Applicant: Maxell, Ltd., Kyoto (JP)

(72) Inventors: Nozomu SHIMODA, Kyoto (JP); Yasuhiko KUNII, Kyoto (JP); Yoshiho SEO, Kyoto (JP)

(21) Appl. No.: 19/571,607

(22) Filed: Mar. 19, 2026

(30) Foreign Application Priority Data
Mar. 27, 2025 (JP) 2025-053632
Nov. 21, 2025 (JP) 2025-202100

(51) Int. Cl. G09G 3/00; B60Q 1/52

(52) U.S. Cl. CPC G09G 3/002; B60Q 1/52; G09G 2380/10

(57) ABSTRACT

A technique capable of displaying an image for a driver and an image for persons who are present near a vehicle more appropriately is provided. The present disclosure contributes to "3. Good-Health and Well-Being" of Sustainable Development Goals. An information projection apparatus includes: a receiver configured to acquire information on a vehicle; an image projector configured to project an image based on the information acquired by the receiver; and a control unit configured to control projection of the image, in which the control unit projects an image evaluated by a preset projection condition in accordance with priority based on the information.

### INCORPORATION BY REFERENCE

This application is based upon and claims the benefit of priority from Japanese patent application No. 2025-202100, filed on Nov. 21, 2025 and Japanese patent application No. 2025-053632, filed on Mar. 27, 2025, the disclosure of which is incorporated herein in its entirety by reference.

### BACKGROUND

The present disclosure relates to an information projection apparatus, an information projection system, and an information projection method. As disclosed in Patent Literature 1 and 2, techniques for projecting information on a road surface are known.

Patent Literature 1 discloses a projection device for a vehicle that projects a path guidance image onto a road surface ahead of an own vehicle. This projection device for the vehicle includes path search means for searching for a current position of an own vehicle and a path from the current position to a set destination, and projection means for projecting, when the own vehicle has approached a junction point on the path to such an extent that it can be visually recognized by an occupant, a path guidance image for guiding the own vehicle in a branch direction onto a road surface ahead of the own vehicle based on the path information searched by the path search means.

Patent Literature 2 discloses a technique capable of clearly alerting mobile bodies such as pedestrians, and discloses, as one example, a road surface projection method. This road surface projection method includes a step of storing, in advance, image data of an image to be projected onto a road surface; a step of monitoring a surrounding region of an own vehicle; a step of determining a mobile body based on a result of monitoring; and a step of setting a determination region in the monitored surrounding region, reading out the image data that is stored in advance when the determined mobile body is present in the determination region, and projecting the image in a position of a road surface near the mobile body.

Patent Literature 1: Japanese Unexamined Patent Application Publication No. 2012-247369

Patent Literature 2: Japanese Unexamined Patent Application Publication No. 2008-7079

### SUMMARY

It is required to provide a technique capable of displaying an image for a driver and an image for vehicles and persons near the own vehicle more appropriately.

Further, according to an aspect of the present disclosure, the following information projection apparatus is provided. This information projection apparatus includes: a receiver configured to acquire information on a vehicle; an image projector configured to project an image based on the information acquired by the receiver; and a control unit configured to control projection of the image. The control unit projects an image evaluated by a preset projection condition in accordance with priority based on the information.

According to the present disclosure, a technique capable of displaying an image for a driver and an image for vehicles and persons near the own vehicle more appropriately is provided. Note that problems, configurations, and effects other than those described above will be made clearer through the description of embodiments for implementing the following disclosure.

The above and other objects, features and advantages of the present disclosure will become more fully understood from the detailed description given hereinbelow and the accompanying drawings.

### BRIEF DESCRIPTION OF DRAWINGS

FIG. 1 is a diagram showing one example of an overview of a vehicle on which an information projection apparatus is mounted;

FIG. 2 is a diagram showing one example of components provided in the vehicle;

FIG. 3A is a diagram showing one example of image display when information is projected onto a road surface ahead of the vehicle;

FIG. 3B is a diagram showing one example of image display when information is projected onto a road surface behind the vehicle;

FIG. 4A is a diagram showing one example of components of a projection apparatus;

FIG. 4B is a diagram showing one example of components of the projection apparatus;

FIG. 4C is a diagram showing one example of components of the projection apparatus;

FIG. 5A is a diagram for describing an example of arrangement of optical elements and the like;

FIG. 5B is a diagram for describing an example of arrangement of optical elements and the like;

FIG. 5C is a diagram for describing an example of arrangement of optical elements and the like;

FIG. 6 is a diagram showing one example of a display region of an image viewed from a driver;

FIG. 7 is a diagram for describing one example of a display region onto which image light is projected;

FIG. 8 is a flowchart for describing one example of information projection;

FIG. 9A is a block diagram showing one example of components for projecting information;

FIG. 9B is a block diagram showing one example of components for projecting information;

FIG. 10 is a block diagram showing one example of components for projecting information;

FIG. 11 is a block diagram showing one example of components for projecting information;

FIG. 12 is a block diagram showing one example of components for projecting information;

FIG. 13 is a block diagram showing one example of components for projecting information;

FIG. 14 is a block diagram showing one example of components for projecting information;

FIG. 15 is a block diagram showing one example of components for projecting information;

FIG. 16 is a block diagram showing one example of components for projecting information;

FIG. 17A is a block diagram showing one example of components for projecting information;

FIG. 17B is a block diagram showing one example of components for projecting information;

FIG. 18 is a diagram for describing one example of processing for setting priority of projection conditions based on setting information set by a user;

FIG. 19 is a flowchart for describing one example of processing for connecting a vehicle (controller) to a mobile terminal and processing for changing a projection image;

FIG. 20A is a diagram showing examples of display of the mobile terminal in the processing for changing the projection image, and examples of display of a vehicle interior image display device and voice output;

FIG. 20B is a diagram showing examples of display of the mobile terminal in the processing for changing the projection image, and examples of display of a vehicle interior image display device and voice output;

FIG. 20C is a diagram showing examples of display of the mobile terminal in the processing for changing the projection image, and examples of display of a vehicle interior image display device and voice output;

FIG. 20D is a diagram showing examples of display of the mobile terminal in the processing for changing the projection image, and examples of display of a vehicle interior image display device and voice output;

FIG. 21 is a diagram for describing one example of processing for evaluating a projection condition, processing for setting priority of projection conditions, and processing for evaluating priority of images;

FIG. 22 is a flowchart for describing one example of processing for evaluating a projection condition, processing for setting priority of projection conditions, and processing for evaluating priority of images;

FIG. 23 is a diagram for describing monitors and priority change events, and a timing when the priority is checked and specific examples of processing for changing priority;

FIG. 24A is a diagram for describing one example of types of the priority change events and processing for changing priority;

FIG. 24B is a diagram for describing one example of types of the priority change events and processing for changing priority;

FIG. 25 is a diagram for describing a specific example of interval setting when the projection image is changed;

FIG. 26 is a diagram for describing a specific example of setting of priority of projection conditions; and

FIG. 27 is a diagram for describing a specific example of evaluation of the priority of projection images in a case where priority of projection conditions is set.

### DESCRIPTION OF EMBODIMENTS

Hereinafter, with reference to the drawings, embodiments of the present disclosure will be described. The embodiments, which are examples for describing the present disclosure, are omitted and simplified as appropriate for the sake of clarification of the description. The present disclosure may be implemented in other various forms. Unless otherwise stated, each of components may be singular or plural.

The position, the size, the shape, the range, and the like of each component shown in the drawings may not indicate the actual position, size, shape, range, and the like in order to facilitate understanding of the disclosure. Therefore, the present disclosure is not necessarily limited to the position, the size, the shape, the range, and the like disclosed in the drawings.

While various kinds of information may be described using expressions such as "table", "list", "queue", or the like, these various kinds of information may be expressed by other data structures. For example, various kinds of information such as an "XX table", an "XX list", and an "XX queue" may be referred to as "XX information". While expressions like "identification information", "identifier", "name", "ID", "number", or the like are used when identification information is explained, they may be replaced by each other.

When there are a plurality of components having the same or similar functions, they may be described using the same symbols with different subscripts. Further, when there is no need to distinguish between these components, the subscripts may be omitted in the description.

In the embodiments, processing performed by executing a program may be described. Here, a computer executes a program by a processor (e.g., CPU, GPU), and performs processing defined by the program using storage resources (e.g., memory), an interface device (e.g., communication port), and the like. Therefore, a main subject of processing performed by executing the program may be a processor. Likewise, the main subject of the processing performed by executing the program may be a controller, a device, a system, a computer, or a node including a processor. The main subject of the processing performed by executing the program may be a calculation unit, and may include dedicated circuits that perform specific processing. The dedicated circuits are, for example, a Field Programmable Gate Array (FPGA), an Application Specific Integrated Circuit (ASIC), a Complex Programmable Logic Device (CPLD), or the like.

The program may be installed in a computer from a program source. The program source may be, for example, a program distribution server or a storage medium that can be read by the computer. When the program source is a program distribution server, the program distribution server may include a processor and a storage resource that stores a program to be distributed, and the processor of the program distribution server may distribute, to another computer, the program to be distributed. Further, in the embodiments, two or more programs may be implemented as one program, or one program may be implemented as two or more programs.

In the embodiments, one example of a technique for displaying information on a road surface by using a projection apparatus mounted on a vehicle will be described. Note that, in the embodiments, with respect to a vehicle and a driver, the horizontal direction is the left-right direction, the lateral direction of the vehicle or the width direction of the vehicle, the vertical direction is the up-down direction or the longitudinal direction of the vehicle, and the vertical direction that is perpendicular to the lateral direction or the longitudinal direction of the vehicle is a front-rear direction of the vehicle or a traveling direction of the vehicle.

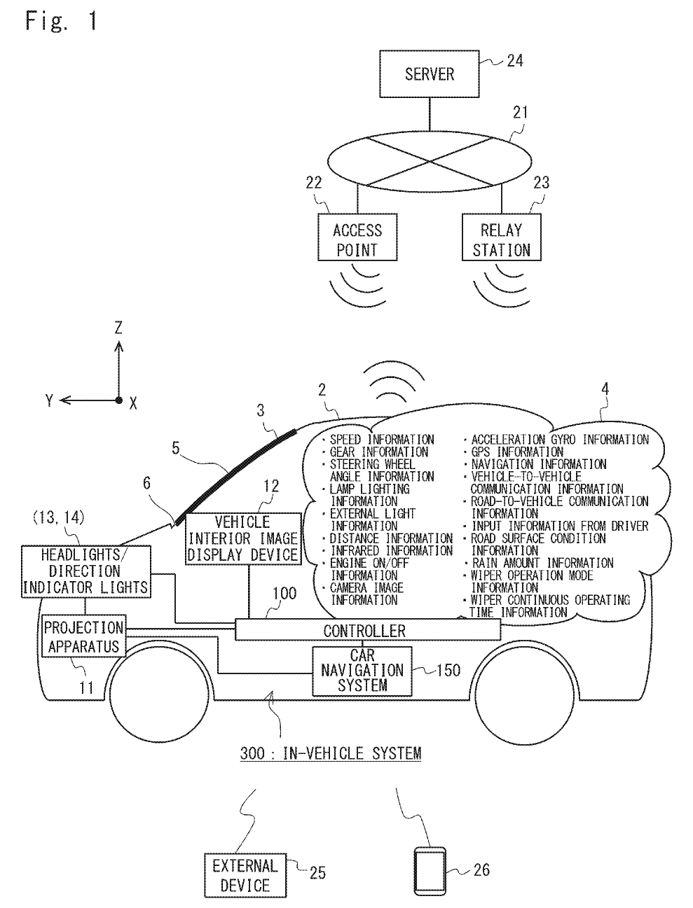

FIG. 1 is a diagram showing an overview of the vehicle. As shown in FIG. 1, a vehicle 2 includes, for example, a projection apparatus 11 (information projection apparatus), a vehicle interior image display device 12, a car navigation system 150, headlights 13, tail lights, direction indicator lights 14, and a controller 100. Further, an in-vehicle system 300 including these components is configured in the vehicle 2. An in-vehicle network is implemented in this in-vehicle system 300, and the controller 100 can transmit or receive data or information to or from these components, components that will be described later, and so on. A Controller Area Network (CAN), in-vehicle ethernet, Local Interconnect Network (LIN), or the like is implemented, for example, in the in-vehicle system 300.

Further, the in-vehicle system 300 can communicate with the exterior of the vehicle via a communication apparatus. A direct communication method or an indirect communication method is used as one example of communication with the exterior of the vehicle. In the direct communication method, 760 MHz band, 5.9 GHz band and the like are internationally used as Intelligent Transport System (ITS) communication bands, where direct communication between vehicles, between a road and a vehicle, between a vehicle and a pedestrian is performed, whereas in the indirect communication method, mobile phone bands other than 5.9 GHz is used and indirect communication is performed via a mobile carrier network. The in-vehicle system 300 can transmit or receive, for example, data or information to or from, a server 24 connected to the network 21 via, for example, an access point 22 or a relay base station 23 on a network 21. Further, the in-vehicle system 300 may communicate with other vehicles, an external device 25, or an information terminal 26 owned by a pedestrian, or may communicate with infrastructure such as a terminal installed on the road on which the vehicle travels. As an example of the road-to-vehicle communication, traffic jam information or weather information is received using radio beacons or optical beacons.

Vehicle information 4, which is one example of data or information acquired by the in-vehicle system 300, includes, for example, in-vehicle sensor information such as speed information, gear information, steering wheel angle information, lamp lighting information, external light information, distance information, infrared information, engine ON/OFF information, camera image information, acceleration gyro information, GPS information, navigation information, vehicle-to-vehicle communication information, road-to-vehicle communication information, pedestrian-to-vehicle communication information, Light Detection and Ranging (Lidar), road surface condition information, rain-related information, or wiper-related information. The camera image information includes vehicle interior camera image information or vehicle exterior camera image information. The GPS information includes current time information, latitude information, and longitude information. These vehicle information items can be acquired, for example, from a sensor that will be described later. The navigation information is map information indicating the direction from the current position to the destination that is generated by the car navigation system 150 based on position information obtained by a GPS.

Further, the vehicle information 4 includes information input by the driver. The driver can input information by using an appropriate device to be used to input information. This device may be a device that is provided in a vehicle in advance. Further, this device may be an input device, a tablet, a smartphone, wearable equipment like an Augmented Reality (AR) glass or a Head Mounted Display (HMD), or an external device such as a personal computer that can be connected to the in-vehicle system 300 by a wire or wirelessly.

The in-vehicle system 300 can perform various kinds of control such as drive control or display control by using acquired data or information.

The projection apparatus 11 projects image light for displaying information. Specific configuration examples of the projection apparatus 11 will be described later. The driver, people around the vehicle 2, that is, pedestrians who are walking near the own vehicle, drivers and passengers of other vehicles driving near the own vehicle, and the like can visually recognize images projected by the projection apparatus 11.

The vehicle interior image display device 12 generates image light for displaying information, and projects image light toward a predetermined display region 5 of the windshield 3. Accordingly, the vehicle interior image display device 12 can cause, for example, a virtual image corresponding to the projection image to be superimposed on the landscape to cause the driver of the vehicle (driver's viewpoint) to visually recognize this image. While image light is projected onto the display region 5 of the windshield 3 in this example, an image projector that projects image light may be a projection member such as a combiner. The vehicle interior image display device 12 may be, for example, a known Head-Up Display (HUD) including a light source, a display panel forming a display image, a control unit, and the like.

The car navigation system 150 is electronic equipment. The car navigation system 150 is a device indicating a current position and a direction to a destination by position information by GPS by using, for example, map information. The car navigation system 150 can present efficient route to the destination by using traffic information such as Vehicle Information and Communication System (VICS, registered trademark).

In this example, a pair of right and left headlights 13 are provided at a front of a vehicle. A lamp serving as a luminous body is incorporated into each of the headlights 13. The direction indicator lights 14 are devices for indicating a direction at the time of a right turn/left turn, a lane change, or the like, to surroundings. Like the headlights 13, a pair of right and left direction indicator lights 14 are provided at a front of the vehicle.

The controller 100 is an electronic control unit mounted in the vehicle 2, and includes, as one example, a processing apparatus (e.g., central processing unit), a storage device, and an input/output device (I/O unit). The storage device can be formed using, for example, a main storage device and an auxiliary storage device. The main storage device is a working area of the processing apparatus, and the processing apparatus stores data in the main storage device and executes data processing. Note that the main storage device is, for example, a Random Access Memory (RAM). The auxiliary storage device, which is a non-volatile storage device, stores data in a non-volatile manner. The auxiliary storage device is, for example, a Read Only Memory (ROM).

Data or information is input to the controller 100 via the input/output device and the in-vehicle network. Further, the controller 100 can control various devices connected to the in-vehicle network via the input/output device and the in-vehicle network.

The vehicle information 4 and information acquired from a server 24 are input, for example, to the controller 100 via the input/output device. Then the controller 100 may control, based on the acquired information, drive of the headlights 13, drive of the direction indicator lights 14, an operation of the projection apparatus 11, an operation of the vehicle interior image display device 12, an operation of the car navigation system 150, and so on.

The projection apparatus 11 may be connected to various sensors mounted on the vehicle 2, devices mounted on the vehicle 2 (e.g., car navigation system 150), a communication apparatus used to communicate with the outside of the vehicle, and the like, to acquire data or information. Then, the projection apparatus 11 may generate, by using the acquired data or information, image light for displaying information and project the image light.

Note that the communication between the projection apparatus 11 and the controller 100 may be omitted. Here, the projection apparatus 11 may acquire, for example, data or information from a component other than the controller 100 by communication based on CAN, in-vehicle ethernet, or the like. The same can be applied to the vehicle interior image display device 12.

Further, the controller 100 may generate image data using the acquired data or information and transmit the generated image data to the projection apparatus 11, and the projection apparatus 11 may generate image light for displaying information based on the image data generated by the controller 100 to project the image light. Alternatively, the controller 100 may not generate image data, and an image generation 527 (described later) may generate image data and transmit the generated image data to the projection apparatus 11. Here, the controller 100 and the projection apparatus 11 may perform communication based on, for example, FPD-Link III, or Gigabit Multimedia Serial Link (GMSL), and the projection apparatus 11 may acquire the image data from the controller 100. Further, the projection apparatus 11 performs image processing on the acquired image data that needs to be processed, and the image processing is processing regarding distortion correction, color correction, brightness correction, contrast correction, conversion (e.g., decoding), or the like of an image. The image data may be held by a storage device of the controller or the projection apparatus in advance, or may be processed in real time instead of being stored in the storage device. When the storage device of the controller or the projection apparatus holds the image data, the stored image data may be sequentially changed by update of the system or a user's operation by a wire or wirelessly. Like in the above description, this projection apparatus 11 may be connected to various sensors mounted on the vehicle, devices mounted on the vehicle 2 (e.g., car navigation system 150), a communication apparatus used to communicate with the outside of the vehicle, and the like, and may acquire data or information by communication based on CAN, in-vehicle ethernet, or the like. Then this projection apparatus 11 may generate image light for displaying information based on the acquired information and project the image light. The same can be applied to the vehicle interior image display device 12.

Further, the controller 100 may control the headlights 13 and the projection apparatus 11 in cooperation with each other. The controller 100 may cause, for example, the headlights 13 to be turned on and cause the projection apparatus 11 to project image light ahead of the vehicle. Further, the controller 100 may cause, for example, the headlights 13 to be turned off and cause the projection apparatus 11 to generate an image of information to be displayed to project image light ahead of the vehicle. That is, the headlights 13 and the projection apparatus 11 may perform the cooperative operation via the controller 100.

On the other hand, the headlights 13 and the projection apparatus 11 may operate without using the controller 100. For example, the headlights 13 and the projection apparatus 11 may be connected to each other, and the operation of the headlights 13 may be controlled by the projection apparatus 11 (specifically, projection apparatus controller of the projection apparatus 11). The projection apparatus 11 may cause, for example, the headlights 13 to be turned on, generate an image of information to be displayed, and project image light ahead of the vehicle. Further, the projection apparatus 11 may cause, for example, the headlights 13 to be turned off, generate an image of information to be displayed, and project the image light ahead of the vehicle.

As one example, the projection apparatus 11 may be mounted on a front part of the vehicle body, and image light from the projection apparatus 11 may be projected onto a road surface ahead of the own vehicle. The projection apparatus 11 may be mounted, for example, near the roof or the like of the vehicle body 2. Further, the projection apparatus 11 may be mounted, for example, on a side mirror part, on the roof, or the side, the bottom, or the like of the vehicle body 2. Note that the present disclosure is not limited thereto.

The number of projection apparatuses 11 mounted on the vehicle may be either one or plural. A pair of projection apparatuses 11 may be, for example, mounted on a front end of the vehicle 2. Further, the projection apparatuses 11 may be, for example, integrally incorporated into the headlights 13. When the projection apparatuses 11 are integrally incorporated into the headlights 13, light sources of the headlights 13 may be used as light sources for projection.

As one example, the projection apparatus 11 may be mounted in a rear part of the vehicle body, and image light from the projection apparatus 11 may be projected onto a road surface behind the own vehicle. Further, a pair of projection apparatuses 11 may be mounted, for example, in a rear end of the vehicle 2. Further, the projection apparatuses 11 may be integrally incorporated into, for example, tail lights. When the projection apparatuses 11 are integrally incorporated into the tail lights, light sources of the tail lights can be used as light sources for projection. The above tail lights may instead be brake lights or reverse lights. Hereinafter, the term "tail lights" may be replaced by "brake lights" or "reverse lights".

Further, the controller 100 may control the tail lights and the projection apparatus 11 in cooperation with each other. The controller 100 may cause, for example, the tail lights to be turned on, cause the projection apparatus 11 to generate an image of information to be displayed, and cause image light to be projected behind the vehicle. Further, the controller 100 may cause, for example, the tail lights to be turned off, cause the projection apparatus 11 to generate an image of information to be displayed, and cause image light to be projected behind the vehicle. That is, the tail lights and the projection apparatus 11 may perform the cooperative operation via the controller 100.

On the other hand, the tail lights and the projection apparatus 11 may operate without using the controller 100. For example, the tail lights and the projection apparatus 11 may be connected to each other and the operations of the tail lights may be controlled by the projection apparatus 11 (specifically a projection apparatus controller of the projection apparatus 11). The projection apparatus 11 may cause, for example, the tail lights to be turned on, generate an image of information to be displayed, and project the image light behind the vehicle. Further, the projection apparatus 11 may cause, for example, the tail lights to be turned off, generate an image of information to be displayed, and project the image light behind the vehicle.

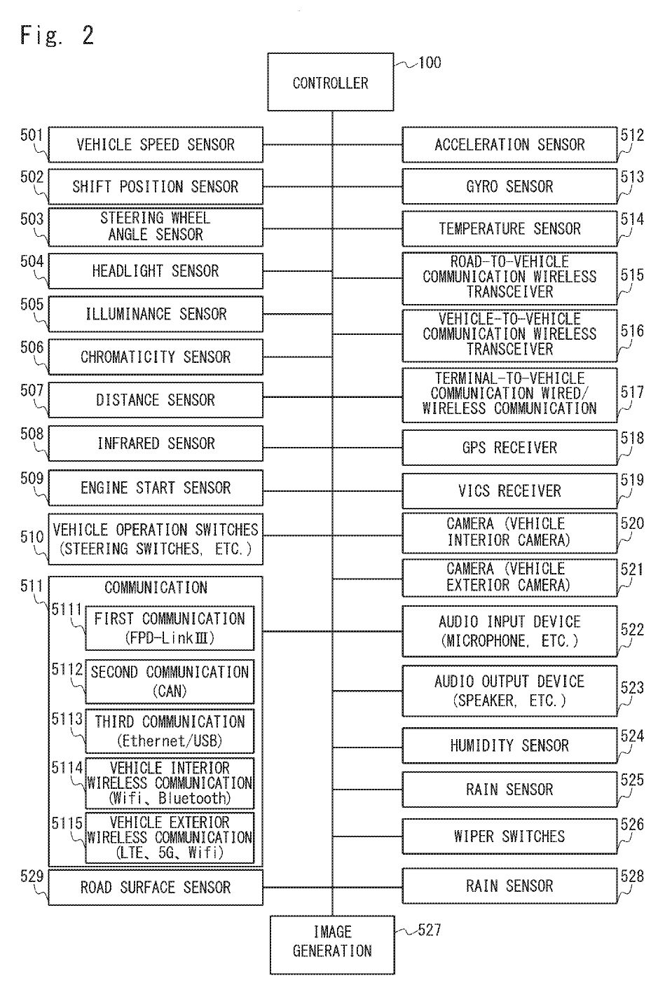

The information such as the vehicle information 4 is acquired by using devices such as a camera and various kinds of sensors. FIG. 2 shows an example in which the controller 100 and various kinds of devices are connected to each other. Further, a control unit of each of the projection apparatus 11, the vehicle interior image display device 12, the car navigation system 150, and the like may be connected to the devices shown in FIG. 2, and may directly acquire information without using the controller 100. Some of various kinds of devices in FIG. 2 may be deleted, other types of devices may be added to them, or some of them may be replaced with other types of devices as appropriate.

Further, the controller 100 may control the direction indicator lights 14 and the projection apparatus 11 in cooperation with each other. The controller 100 may cause, for example, the direction indicator lights 14 to be turned on, cause the projection apparatus 11 to generate an image of information to be displayed, and cause image light to be projected ahead of or behind the vehicle. Further, the controller 100 may cause, for example, the direction indicator lights 14 to be turned off, cause the projection apparatus 11 to generate an image of information to be displayed, and cause the image light to be projected ahead of or behind the side of the vehicle. That is, the direction indicator lights 14 and the projection apparatus 11 may perform cooperative operation via the controller 100. Further, the direction indicator lights 14 may be controlled to be ON and OFF by a driver's operation. As one example, the projection apparatus may be provided so as to project image light toward the road surface on the side of the vehicle 2.

A vehicle speed sensor 501 detects the speed of the vehicle 2 and is used to generate speed information representing a detection result. A shift position sensor 502 detects the current gear and is used to generate gear information representing a detection result. A steering wheel angle sensor 503 detects the current steering wheel angle and is used to generate steering wheel angle information representing a detection result.

A headlight sensor 504 detects, for example, whether the headlights 13 are on or off. Further, the headlight sensor 504 may detect brightness when the headlights 13 are turned on. The headlight sensor 504 is used to generate lamp lighting information representing a detection result. Further, the vehicle 2 may be provided with a high/low sensor that detects the state of high beam headlights or low beam headlights of the headlights 13, and the high/low sensor is used to generate information indicating the high beam headlights or the low beam headlights. Further, the vehicle 2 may be provided with a tail light sensor (not shown). The tail light sensor detects, for example, whether the tail lights are on or off. Further, the tail light sensor may detect brightness when the tail lights are turned on. The tail light sensor is used to generate lamp lightning information representing a detection result. Likewise, although not shown in the drawings, sensors that detect whether brake lights, reverse lights, hazard lights, and the direction indicator lights 14 are on or off, and the lighting brightness may be provided.

An illuminance sensor 505 and a chromaticity sensor 506 detect external light of the vehicle 2, and is used to generate external light information representing a detection result. Further, the chromaticity sensor 506 detects the color of the road surface near the vehicle 2, which may be used to generate projection surface color information representing a detection result. A distance sensor 507 detects a distance between the vehicle 2 and an external object, a distance between the external object and an object, or the like, and is used to generate distance information representing a detection result. An infrared sensor 508 detects the presence or absence of an object in the vicinity of the vehicle as well as the distance thereto, and is used to generate infrared information representing a detection result. An engine start sensor 509 detects whether the engine is on or off and is used to generate ON/OFF information representing a detection result.

Vehicle operation switches 510 are various kinds of switches operated by the driver or the like, and are used to generate operation information indicating whether these switches are on or off. The vehicle operation switches 510 relate to steering switches, switches on the dashboard, door switches of the vehicle, switches on an armrest, switches on a center console, and so on.

A communication 511 is a component that is used for communication, and includes, for example, a first communication 5111, a second communication 5112, a third communication 5113, a vehicle interior wireless communication 5114, and a vehicle exterior wireless communication 5115.

The first communication 5111 is, for example, a component that performs communication by FPD-Link III, and includes a communication line and a communication apparatus that are used for communication by FPD-Link III.

A communication protocol (CAN communication protocol) is implemented in the second communication 5112, and the second communication 5112 includes a communication line and a communication apparatus that are used for communication by CAN.

The third communication 5113 is a component that performs communication by in-vehicle ethernet. A communication protocol of the in-vehicle ethernet is implemented in the third communication 5113, and the third communication 5113 includes a communication line and a communication apparatus used for communication by in-vehicle ethernet. Note that the third communication 5113 may include a port of a Universal Serial Bus (USB), and a driver or the like may connect a device (e.g., a USB memory, or a device having a computer function) to the above port as appropriate. Then, the third communication 5113 may perform communication by in-vehicle ethernet between the device connected to the port and the component of the connection destination.

The vehicle interior wireless communication 5114 is a component that communicates with information equipment inside the vehicle. A communication protocol is implemented in the vehicle interior wireless communication 5114, and the vehicle interior wireless communication 5114 includes a wireless device. The vehicle interior wireless communication 5114 performs, for example, wireless communication by Wifi (registered trademark) or Bluetooth (registered trademark). Note that the vehicle interior wireless communication 5114 may perform, for example, near-field wireless communication such as Near Field Communication (NFC).

The vehicle exterior wireless communication 5115 is a component that communicates with the outside of the vehicle 2. A communication protocol is implemented in the vehicle exterior wireless communication 5115, and the vehicle exterior wireless communication 5115 includes a wireless device. The vehicle exterior wireless communication 5115 performs, for example, wireless communication by Long Term Evolution (LTE), 5G, or Wifi.

Note that the configuration of the communication 511 may be changed as appropriate. The communication 511 may be configured to be able to perform communication by, for example, LIN. Further, the communication 511 may be configured to be able to perform communication by, for example, GMSL.

An acceleration sensor 512 and a gyro sensor 513, which detect the acceleration and angular velocity of the vehicle 2, are used to generate acceleration gyro information representing the attitude and behavior of the vehicle 2. A temperature sensor 514 detects temperatures outside and inside the vehicle, the temperature on the road surface, and the like, which are used to generate temperature information representing a detection result.

A road-to-vehicle communication wireless transceiver 515 generates road-to-vehicle communication information by the road-to-vehicle communication between the vehicle 2 and roads, signs, traffic lights, and the like. A vehicle-to-vehicle communication wireless transceiver 516 generates vehicle-to-vehicle communication information by the vehicle-to-vehicle communication between the vehicle 2 and other vehicles in the vicinity. A terminal-to-vehicle communication wired/wireless communication 517 is a device that acquires information from a device (e.g., WiFi device) connected to an LTE network through wired communication or wireless communication. The controller 100 or the control unit can acquire information transmitted and received by the LTE network via the terminal-to-vehicle communication wired/wireless communication 517.

A GPS receiver 518 generates GPS information obtained by receiving GPS signals from GPS satellites. For example, the current time, the latitude, and the longitude can be acquired by the GPS receiver 518. A VICS receiver 519 generates VICS information obtained by receiving VICS signals. The VICS signals here include traffic jam information, weather information, and the like by radio beacons or optical beacons. The GPS receiver 518 and the VICS receiver 519 may be provided as a part of the navigation system.

A vehicle interior camera 520 and a vehicle exterior camera 521, which image the vehicle interior and the vehicle exterior, are used to generate camera image information inside the vehicle and camera image information outside the vehicle. Specifically, the vehicle interior camera 520 is, for example, a camera for Driver Monitoring System (DMS) that images the driver's attitude, eye position, movement, and the like. In this case, by analyzing the captured image, the fatigue level, the gaze position, and the like of the driver can be grasped.

The driver's voice is input to an audio input device 522, and the audio input device 522 is used to generate voice information. The driver can enter the operation content via the audio input device 522 by making a voice. An audio output device 523 is, for example, a device that outputs voice processed by the controller 100 or the control unit.

A humidity sensor 524, which detects humidity, is used to generate humidity information. The humidity sensor 524 may detect the humidity of the outside of the vehicle 2 or the road surface, and generate humidity information outside the vehicle 2. Further, the humidity sensor 524 may detect the humidity inside the vehicle 2, and generate humidity information inside the vehicle.

A rain sensor 525, which detects rain, is used to generate rain information. Wiper switches 526 detect whether the wipers 6 are on or off, and are used to generate ON/OFF information on the wipers 6. A direction indicator light switch (not shown), which detects an operation of the direction indicator lights 14 by the driver, is used to generate direction indicator light information.

The image generation 527 may generate image information based on information acquired from each sensor, information from the external device 25 or the mobile terminal 26, information from the Internet, or the like, or may generate image information based on the information that the controller 100 has acquired. Information other than the vehicle includes information from the external device 25 or the mobile terminal 26, information from the Internet, and so on. Alternatively, the image generation 527 may not be included. In this case, the controller 100 may be configured as a function of generating an image.

A rain sensor 528 detects the amount of the rain and the size of raindrops. The rain sensor 528 can measure the state of the rain since the amount of light entering the detector decreases due to rain. The amount of rain detected by the rain sensor 528 may be used to generate related information such as an operating time and the like of the wipers 6. Further, the traveling speed of the own vehicle 2 may be associated with the detection result of the rain sensor 528 to change the operation state of the wipers 6, or the associated information may be used to correct related information such as an operating time of the wipers 6.

A road surface sensor 529 detects information regarding the road surface conditions. The road surface sensor 529 may directly measure road surface wetness or may detect friction with the road surface. Alternatively, acceleration may be detected by road surface conditions, or the road surface conditions may be classified into conditions such as dry, semi-dry, wet, slush, fresh snow, compacted snow, or ice from the acceleration waveform.

The controller 100 or the processor may, for example, transmit or receive data or information via wireless communication to acquire information that is necessary for driving. Note that the controller 100 or the processor may acquire information that is necessary for automated driving. Further, the controller 100 or the processor may transmit or receive data or information via, for example, wireless communication to perform processing for updating data or information. The controller 100 or the processor may update, for example, various kinds of data or information (map data, data used for image processing, software, or the like) as update processing. With regard to this technology, this technology may be referred to as an Over the Air (OTA) technology.

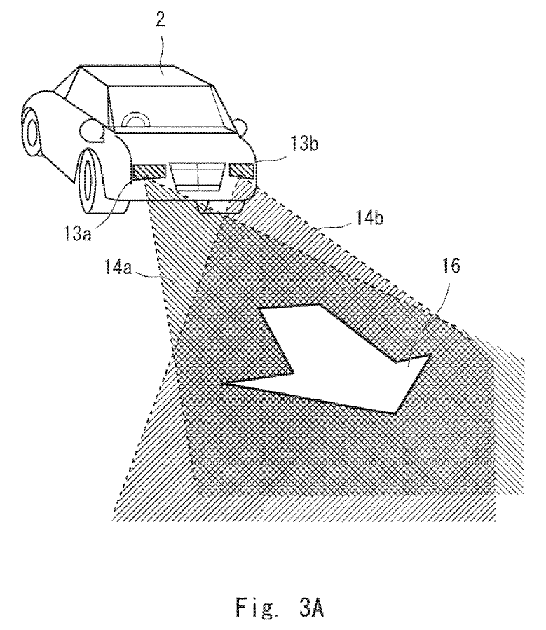

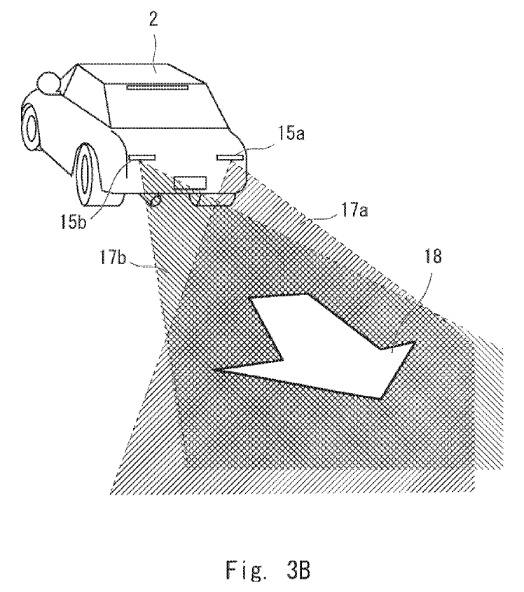

Next, with reference to FIGS. 3A and 3B, one example of information projection by a projection apparatus will be described. As shown in FIG. 3A, image light is projected from the projection apparatus onto a road surface ahead of the vehicle, and FIG. 3A shows a projection region 14a projected from the projection apparatus 11 via a window part 13a on the right front side of the own vehicle 2 and a projection region 14b projected from the projection apparatus 11 via a window part 13b on the left front side of the own vehicle. Projection views of the respective projection regions (14a, 14b) are synthesized and this image (in this example, an arrow 16 regarding display for causing the vehicle 2 to travel straight ahead) is projected onto the road surface ahead of the vehicle 2. While the projection region is divided into left and right projection regions (14a, 14b) in this example, the projection region may be divided into a region near the vehicle and a region far from the vehicle. Further, image light may be projected using only one of the projection apparatuses 11 installed on the left and the right of the vehicle. In this example, the projection apparatuses 11 are incorporated into the headlights 13, and light sources of the headlights 13 are used as light sources for projection. However, as described above, the arrangement of the projection apparatus 11 can be changed as appropriate. The projection apparatus 11 may include a component other than the headlights 13 that is capable of emitting light, and project image light using light emission of this component.

As shown in FIG. 3B, image light is projected from the projection apparatus 11 onto a road surface behind the vehicle, and FIG. 3B shows a projection region 17a projected from the projection apparatus 11 on the right rear side of the own vehicle 2 via a window part 15a on the right rear side of the own vehicle 2 and a projection region 17b projected from the projection apparatus 11 on the left rear side of the own vehicle 2 via a window part 15b on the left rear side of the own vehicle 2. Projection views of the respective projection regions (17a, 17b) are synthesized and this image (in this example, an arrow 18 regarding display for causing the vehicle to travel straight backward) is projected onto a road surface behind the vehicle. While the projection region is divided into left and right projection regions (17a, 17b) in this example, the projection region may divided into a region near the vehicle and a region far from the vehicle. Further, image light may be projected using only one of the projection apparatuses 11 installed on the left and the right of the vehicle. In this example, the projection apparatuses 11 are installed in such a way that light sources of tail lights can be used as light sources for projection. However, as described above, the arrangement of the projection apparatus 11 can be changed as appropriate. The projection apparatus 11 may include a component other than the taillights that is capable of emitting light, and project image light using light emission of this component.

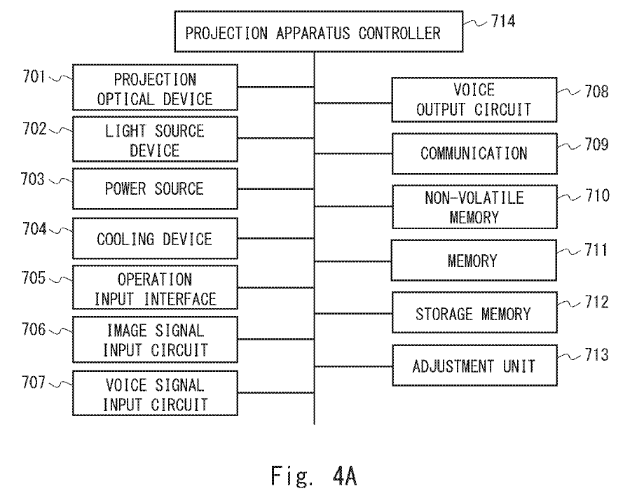

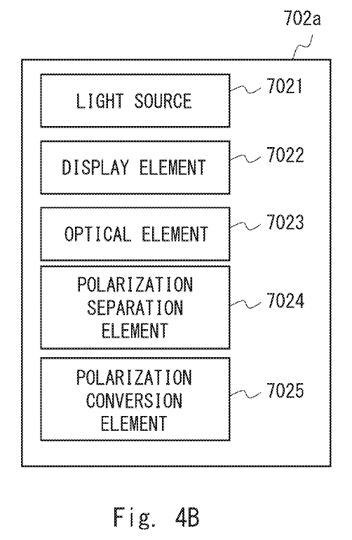

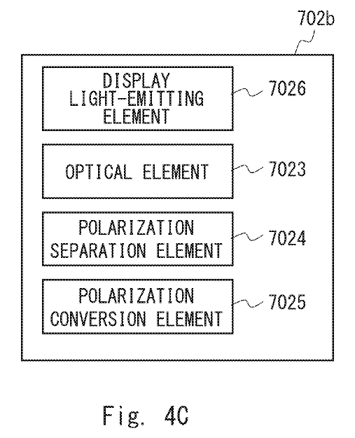

With reference to FIG. 4A, a configuration example of the projection apparatus 11 will be described. The projection apparatus 11 generates, by using, for example, data or information acquired via various sensors and a communication, an image of information to be displayed, and projects image light. Note that, for example, data or information may be input to the projection apparatus 11 from the controller 100. For example, signal data, image data, or the like may be input to the projection apparatus 11 from the controller 100. Then the projection apparatus 11 may perform processing using the input information. Further, for example, in place of the projection apparatus controller of the projection apparatus 11, the controller 100 may be a component for controlling the projection apparatus 11. Further, the projection apparatus controller of the projection apparatus 11 and the controller 100 may share the processing. For example, the controller 100 may perform control for adjusting the brightness of the headlights 13 and the brightness of the tail lights, and the projection apparatus controller of the projection apparatus 11 may perform control for adjusting the brightness of the projection image.

As shown in FIG. 4A, the projection apparatus 11 includes a projection optical device 701 and a light source device 702. Further, the projection apparatus 11 includes a power source 703, a cooling device 704, an operation input interface 705, an image signal input circuit 706, a voice signal input circuit 707, a voice output circuit 708, a communication 709, a non-volatile memory 710, a memory 711, a storage memory 712, an adjustment unit 713, and a projection apparatus controller 714. The projection apparatus controller 714 may be formed as a processing apparatus. The projection apparatus controller 714 may control the operation of the projection apparatus 11. On the other hand, when the control unit is not included, the controller 100 may control the projection apparatus 11.

The projection optical device 701 is a component that is used for projection of light. The projection optical device 701 includes, for example, optical elements such as a lens and/or a mirror.

The light source device 702 is a device capable of generating image light. The light source device may use, for example, a high-pressure mercury lamp, a xenon lamp, an LED light source, or a laser light source, as a light source. Note that the light source device may include optical elements used for light focusing and uniformization.

The power source 703 supplies power to, for example, the light source. Further, the power source 703 supplies power required for each of other units.

The cooling device 704 cools each of parts such as the light source, the power source 703, or the light source device 702 which becomes a high-temperature state using an air cooling method or a liquid cooling method as necessary.

The operation input interface 705 is, for example, an operation button or a light receiving unit of a remote controller, and receives an operation signal input from a user. Upon receiving the operation signal from the user, ON/OFF of a switch (operation switch) for starting the projection apparatus 11 is switched.

The image signal input circuit 706 is an interface apparatus that externally acquires image data. The voice signal input circuit 707 is an interface apparatus that externally acquires voice data. The voice output circuit 708 can output voice which is based on, for example, the voice data input to the voice signal input circuit 707. The voice output circuit 708 may output, for example, an operation sound or an error warning sound.

The communication 709 is an interface apparatus used for external communication. The communication 709 is connected to, for example, an external information processing apparatus (e.g., the controller 100), and inputs and outputs various control signals. The communication 709 may be connected to various sensors, the communication apparatus or the like provided in the vehicle 2, and input and output various kinds of data or information.

The non-volatile memory 710 stores, for example, various kinds of data to be used in a projector function. The data stored in the non-volatile memory 710 includes image data, video data and the like prepared in advance for projecting the image.

The memory 711 stores image data to be projected, control parameters of each unit of the apparatus, and the like.

The storage memory 712 is a device that stores video, images, voice, various kinds of data, and the like. For example, video, images, voice, various kinds of data, and the like may be stored in advance before the product is shipped, or video, images, voice, various kinds of data, and the like acquired from an external device, an external server or the like via the communication 709 may be stored. Further, the projection apparatus controller 714 may acquire data or information externally updated via the communication 709 and update the stored data or information with new data or information. Further, some or all of the stored data or information may be updated with new data or information by user's selection. The video, images, various kinds of data, and the like stored in the storage memory 712 may be output as a projection image. The voice stored in the storage memory 712 may be output from the voice output circuit 708 as voice.

The adjustment unit 713, which can adjust image light, includes, for example, an image adjustment unit and a polarization adjustment unit. The image adjustment unit performs image processing on image data input through the image signal input circuit or image data or video data stored in the non-volatile memory 710. The image processing includes, for example, image distortion correction, scaling processing for enlarging, reducing, and deforming, for example, an image, brightness adjustment processing for changing the brightness of an image, contrast adjustment processing for changing a contrast curve of an image (including adjustment of gradation linearity characteristics of brightness), color correction processing for changing chromaticity of an image, retinex processing for decomposing the image into light components (illumination light components, reflection light components, ambient light components) and changing weighting for each component, and so on. Note that the image adjustment unit is implemented as the projection apparatus controller 714 stores data in the memory 711 and performs image processing.

The polarization adjustment unit adjusts a polarization degree of the image light to be projected. The polarization degree here is a ratio of P polarization components and S polarization components, which are polarization light components included in light (P polarization and S polarization are defined relative to the projection plane). For example, like a polarization separation element and a polarization conversion element that will be described later, the projection apparatus 11 is provided with a component capable of adjusting a polarization degree of emitted light, and the projection apparatus controller 714 adjusts a polarization degree of image light by controlling the above component. Note that the polarization control unit is implemented as the projection apparatus controller 714 causes data (parameters or the like used for control) to be stored in the memory 711 and controls this component. Further, a plurality of projection apparatuses 11 having polarization degrees different from one another may be included and they may be switched.

In the example shown in FIG. 4B, a light source device 702a includes a light source 7021, a display element 7022, an optical element 7023, a polarization separation element 7024, and a polarization conversion element 7025. The light source 7021 generates light for image projection. The optical element 7023 is used for light focusing, uniformization, and so on. Descriptions similar to those made above may be omitted. The polarization separation element 7024 is an element for dividing incident light into S polarization and P polarization. Polarizing beamsplitters are used, for example, for the polarization separation element 7024, and the polarization separation element 7024 separates light by reflecting or transmitting light of a specific polarization state. The polarization conversion element 7025 is an element for converting the polarization degree. For example, a waveplate is used for the polarization conversion element 7025, and the polarization conversion element 7025 changes the polarization state by delaying the phase of the light. In this example, the polarization conversion element 7025 may be connected to an actuator (e.g., motor) used to control an incident angle of the transmitted light, and the adjustment unit 713 or the polarization adjustment unit 722 shown in FIG. 4A may adjust the incident light to have a polarization degree according to the incident angle.

Further, the projection apparatus 11 includes a display element 7022, a display element driver (not shown), and the like. The display element 7022, which is an element which generates an image by modulating transmitting light or reflecting light, is, for example, a transmissive liquid crystal display (LCD) panel, a reflective LCD panel, a Digital Micromirror Device (DMD) (registered trademark) panel, or the like. The display element driver sends a drive signal to the display element 7022, and causes the display element 7022 to generate an image. The display element 7022 may include, besides the component such as the DMD or the LCD that allows a plurality of images to be displayed by a control signal, a component such as a mask type that performs only fixed image display.

In the example shown in FIG. 4C, a light source device 702b does not include a light source, which is backlight of a display element. In this example, the display element itself emits light. Note that descriptions similar to those made above may be omitted.

The light source device 702b includes a display light-emitting element 7026, an optical element 7023, a polarization separation element 7024, and a polarization conversion element 7025. The display light-emitting element 7026 is formed as a self-light-emitting display such as an LED array or an Organic Light Emitting Diode (OLED) display. The optical element 7023 is an optical system used for light focusing, uniformization, and the like. The optical element 7023, the polarization separation element 7024, and the polarization conversion element 7025 are similar to those described with reference to FIG. 4B.

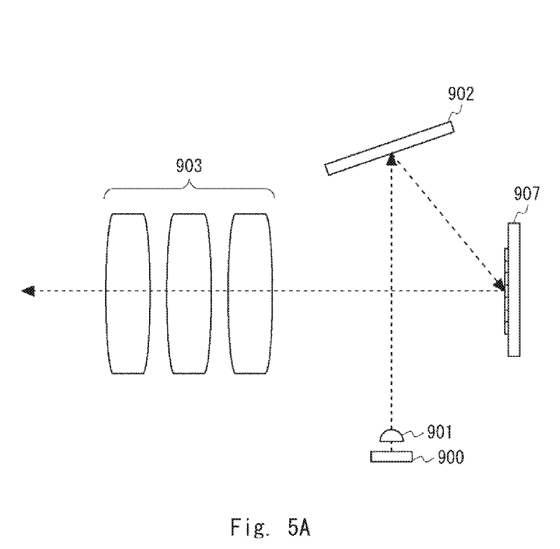

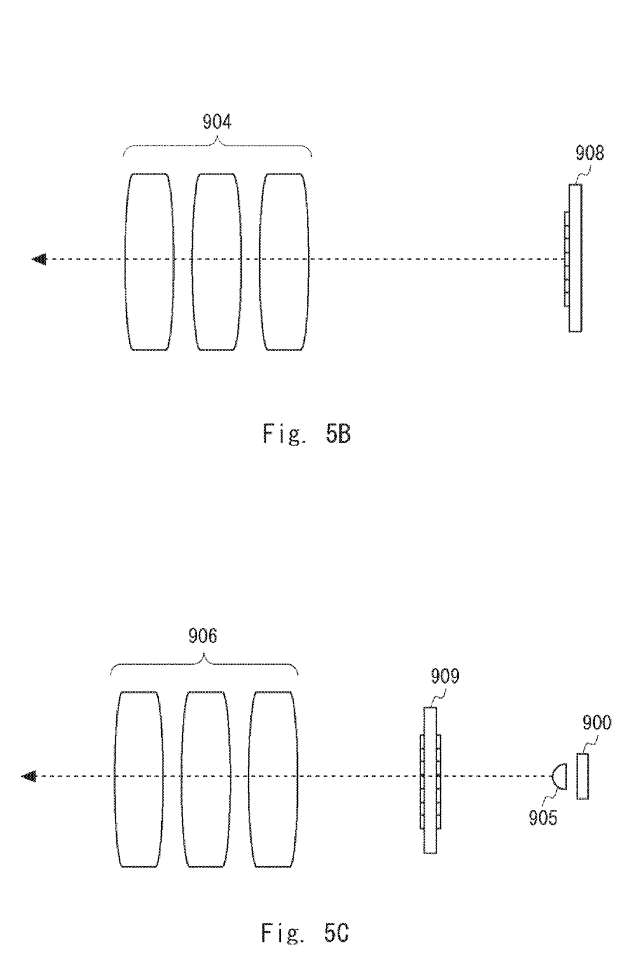

Next, with reference to FIGS. 5A, 5B, and 5C, an example of arrangement of optical elements and the like will be described. FIG. 5A shows an example in which a reflective display element is used, which projects an image by a DMD method. A first optical element 901, which is an optical element that focuses light emitted by a light source 900, is, for example, a collimator. A second optical element 902, which is a mirror, projects the focused light onto a display element 907. The display element 907 is formed as a panel of a DMD type in this example, and the projection of the light is adjusted or controlled for each display pixel. A third optical element 903, which is a component that projects the image light, is formed using optical elements such as a lens and a mirror. A reflective LCD panel may be used as a reflective display element.

FIG. 5B shows an example in which a display light-emitting element 908 itself emits light to project an image. The display light-emitting element 908, which is formed as an LED array panel or an LED matrix panel, and an image is generated by a combination of lighting positions with lighting colors of LEDs on the panel. A fourth optical element 904, which is a component for projecting image light, is formed using optical elements such as a lens and a mirror. Other than the above panel, an OLED display may be used, as a display light-emitting element.

FIG. 5C shows an example in which light is transmitted through a display element 909 to display an image. A fifth optical element 905 is similar to the above first optical element 901. The display element 909 is, for example, a transmissive LCD panel, and an image is generated for the display element 909. A sixth optical element 906, which is a component for projecting image light, is formed using optical elements such as a lens or a mirror. Note that the display element 909 may be configured to arrange, on a side of a light source, a mask in which a predetermined pattern is formed. In this case, it is possible to display a fixed image which is based on a pattern formed in the mask by light that transmits through the mask without being interrupted by the mask, which is the display element. Further, the display element 909 may be configured to arrange, on the side of the light source, lens in which a predetermined pattern is formed. In this case, the display element 909 can display a fixed image which is based on the pattern formed in the lens. Note that the predetermined pattern formed in the lens is formed on the surface of the lens or inside the lens, and the formed pattern partially blocks the transmission of the light or allows the light to partially pass therethrough. The lens used for the display element 909 may be a micro-lens array. In this case, patterns formed in the respective lens are different from one another.

A modification example that includes a light shielding plate in place of the display element shown in FIG. 5C will be described. As one example, the light shielding plate includes a window part that causes light rays from the light source 900 to transmit therethrough. The shape of the window part is not limited, and may be, for example, a geometric shape such as a rectangular shape or a chevron shape, an icon, a letter, or a number. Further, the window part may have a shape that can be changed in accordance with the image to be projected. For example, an image having a rectangular shape is changed to an image having a chevron shape based on information to be acquired and the image having a chevron shape is continuously projected. The sixth optical element 906 is a component that projects light rays that have transmitted through the window part of the light shielding plate onto the road surface, and is formed using optical elements such as lens, a mirror, and an aperture. The length, the size, and the brightness of the image to be projected onto the road surface are controlled by the sixth optical element 906. Further, by changing the shape, the size, the transmittance, and the aperture Duty of the window part of the light shielding plate as well, the length, the size, and the brightness of the image to be projected onto the road surface are controlled. Further, by repeating turning the light source 900 on and off, the image to be projected onto the road surface can be flashed.

Further, as another modification example, a plurality of sets, each set including a light source 900, a first optical element 901, a light shielding plate, and a sixth optical element 906, are provided. Then, the sixth optical element 906 projects, onto a road surface, light rays that have transmitted through window parts of a plurality of light shielding plates in such a way that they overlap each other, whereby it becomes possible to linearly project an image having a rectangular shape onto the road surface. Further, the light rays that have transmitted through the window parts of the plurality of light shielding plates are divided and the divided light rays are projected onto the road surface by the sixth optical element 906, whereby it becomes possible to project images having a rectangular shape that are linearly aligned onto the road surface. Further, by sequentially turning on a plurality of light sources 900, it becomes possible to project, onto the road surface, for example, images having a rectangular shape that are sequentially turned on in a predetermined direction (e.g., a direction away from the vehicle).

Note that while the light sources shown in FIGS. 5A and 5C can each be formed of the light source of the projection apparatus 11, they may be light sources of headlights 13 or tail lights. In this case, the light source of the projection apparatus 11 may be omitted. On the other hand, the light sources shown in FIGS. 5A and 5C may each be a combination of the light source of the projection apparatus 11 with the light source of the headlights 13 or the tail lights. Further, the light source of the projection apparatus 11 may be composed of one device or a plurality of devices. The same is applied to the display element or the light shielding plate corresponding to the light source, and the number thereof may either be one or plural.

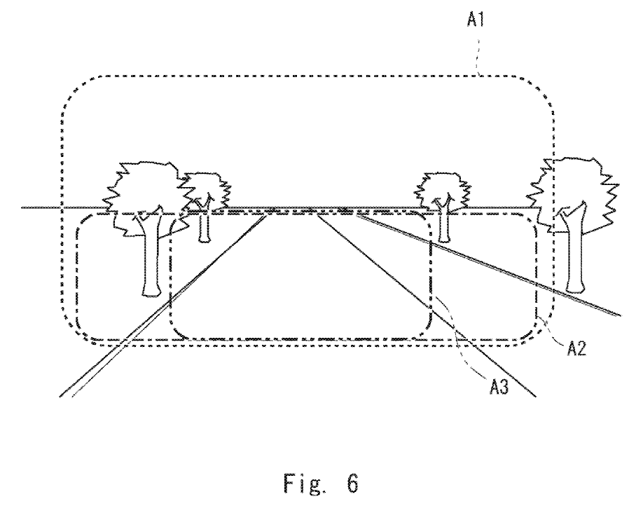

Next, with reference to FIG. 6, one example of a display region of an image as viewed from the driver will be described. FIG. 6 shows an illumination region A1 of high beam headlights of the headlights 13, an illumination region A2 of low beam headlights of the headlights 13, and an image region A3 for road surface image projected by the projection apparatus 11. The illumination region on the upper side of the high beam headlights is irradiated with high beam headlights at a high position. That is, this illumination region can be irradiated with high beam headlights that illuminate the distance brightly. The illumination region on the lower side of the high beam headlights is irradiated with high beam headlights at a low position. Since this region overlaps the projection region of the low beam headlights, low beam headlights may be formed by partially shielding the illumination region of the headlights 13 that can be irradiated with the high beam headlights. Further, the image region A3 projected by the projection apparatus 11 is included in the illumination region A2 of the low beam headlights and the illumination region on the lower side of the illumination region A1 of the high beam headlights. Therefore, the projection apparatus 11 is able to project the image by using the low beam headlights and the high beam headlights of the headlights 13, or a projection apparatus 11 may be provided separately from the headlights 13.

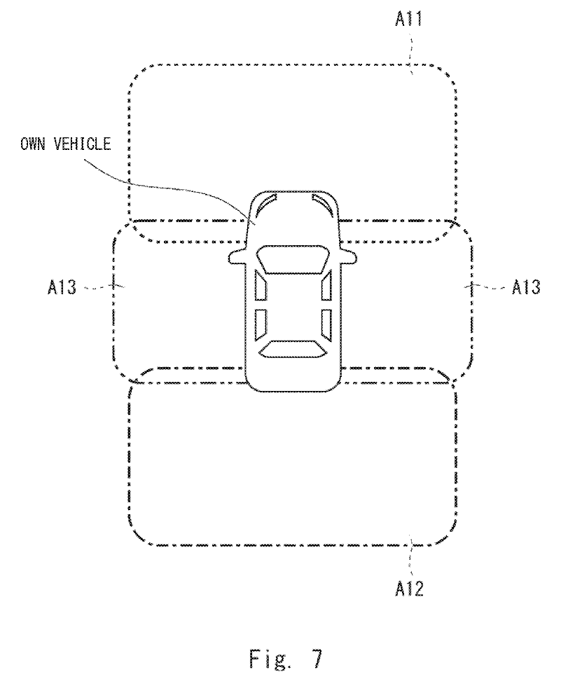

With reference to FIG. 7, one example of a projection region around the vehicle will be described. FIG. 7 shows a vehicle front road surface display region A11, a vehicle rear road surface display region A12, and a vehicle left/right road surface display region A13. The vehicle front road surface display region A11 is a display region that is formed on a of the own vehicle, and the projection apparatus 11 may be provided, as one example, in such a way that the projection apparatus 11 can project image light onto this region and display information in this region. The vehicle rear road surface display region A12 is a display region that is formed on a road surface behind the own vehicle, and the projection apparatus 11 may be provided, as one example, in such a way that the projection apparatus 11 can project image light onto this region and display information in this region. The vehicle left/right road surface display region A13 is a display region formed on a road surface on the left side and/or the right side of the own vehicle, and the projection apparatus 11 may be provided, as one example, in such a way that the projection apparatus 11 can project image light onto this region and display information in this region. This region A13 can be, for example, a region in which vehicles and persons (pedestrians and the like) near the own vehicle can visually recognize displayed information.

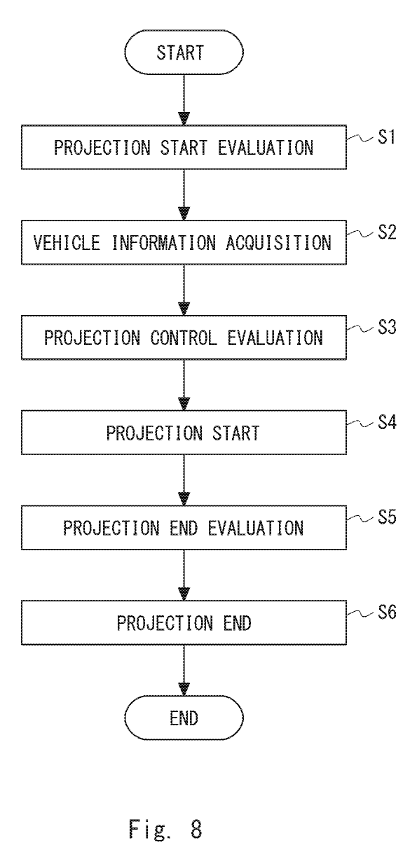

With reference to FIG. 8, one example of the information projection will be described. In the information projection according to this embodiment, the processor controls a projection image, projection of an image, and the like. The controller 100 of the vehicle, the projection apparatus controller of the projection apparatus 11, or the external device or the like may function as the processor. Specifically, the controller 100 may control the projection apparatus 11, the projection apparatus controller of the projection apparatus 11 may control the projection image and projection of the image based on the information from the vehicle or the outside, the controller 100 and the projection apparatus 11 may share the processing, or the external device or the mobile terminal may control the projection image and the projection of the image. When, for example, the controller 100 controls the projection apparatus 11, the controller 100 sends image information which is based on the information from the sensor to the projection apparatus 11. When it is required to further adjust the image, information regarding adjustment of the image is sent to the projection apparatus 11, and the projection apparatus 11 projects an image which is based on the image information and adjustment information. Alternatively, the controller 100 may perform processing for generating the image information, or processing for adjusting the image and processing for generating the information on the adjusted image, only the image information may be sent to the projection apparatus 11, and the projection apparatus 11 may perform only the projection of the image.

FIG. 8 is one example of image projection processing or image projecting processing. In the following embodiments, control regarding image projection (projecting) processing is not particularly limited. As shown in FIG. 8, Step S1 is a projection start evaluation step, where start of projection is evaluated in accordance with preset information or the like in the projection apparatus 11. It is evaluated, for example, that the projection apparatus 11 should be switched on and projection can be started. When it is evaluated that the projection apparatus 11 should be switched off, projection cannot be started.

Next, Step S2 is a vehicle information acquisition step, where vehicle information that is required to perform projection control evaluation in Step S3 is acquired. For example, as the vehicle information, speed information, gear information, steering wheel angle information, external light information, distance information, infrared information, camera image information, acceleration gyro information, GPS information, navigation information, vehicle-to-vehicle communication information, road-to-vehicle communication information, input information from a driver, road surface condition information, rain amount information, wiper operation mode information, wiper continuous operating time information, and the like are acquired.

Next, Step S3 is a projection control evaluation step, where it is evaluated what control is performed on the image to be projected (hereinafter the image to be projected is also referred to as a "projection image") based on the vehicle information acquired in Step S2. For example, in Step S3, a projection image indicating a road surface freezing warning is projected based on the road surface condition information. Further, a projection image indicating a wrong-way driving warning is projected based on the road-to-vehicle communication information. Further, when there are a plurality of conditions for projecting the projection image (hereinafter these conditions are also referred to as "projection condition(s)") are satisfied in Step S3, if all the plurality of projection images are projected onto a display region near the vehicle 2, this projection may cause confusion for the driver. Therefore, which one of the plurality of projection images is to be preferentially projected in Step S3 is determined based on the vehicle information acquired in Step S2.

Next, Step S4 is a projection start step. In Step S4, projection of an image is started based on the evaluation results in Step S3. When, for example, a plurality of projection conditions are satisfied in Step S3, a projection image determined to be preferentially projected starts to be projected onto a display region near the vehicle 2.

Next, Step S5 is a projection end evaluation step. It is evaluated, in Step S5, whether to end the projection of the image based on information regarding an image projection end condition including the vehicle information 4.

Next, Step S6 is a projection end step. When it is determined, in Step S5, that the projection of the image should be ended, the projection of the image is ended in Step S6.

Note that the processing from Steps S2 to S4 may be repeatedly performed until it is evaluated in Step S5 that projection of an image should be ended.

Note that the information projection shown in FIG. 8 is performed by components capable of directly or indirectly controlling the projection apparatus 11. That is, the information projection shown in FIG. 8 may be performed by components which are based on the controller 100, the projection apparatus controller 714 of the projection apparatus 11, another processing apparatus provided in the vehicle, a processing apparatus outside the vehicle, or the like. One of these components may perform this method, or a plurality of components may share each process of this method. In the control of the projection apparatus 11, the controller 100 may transmit signals to the projection apparatus 11 to control the projection apparatus 11. Further, the projection apparatus controller 714 of the projection apparatus 11 may control display of the projection apparatus 11 based on information acquired from the vehicle.

### First Embodiment

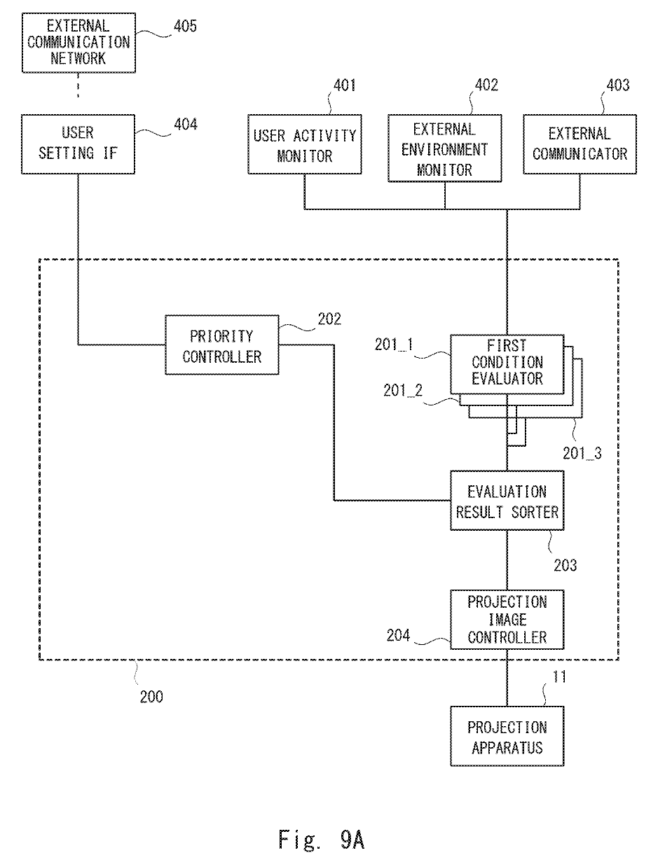

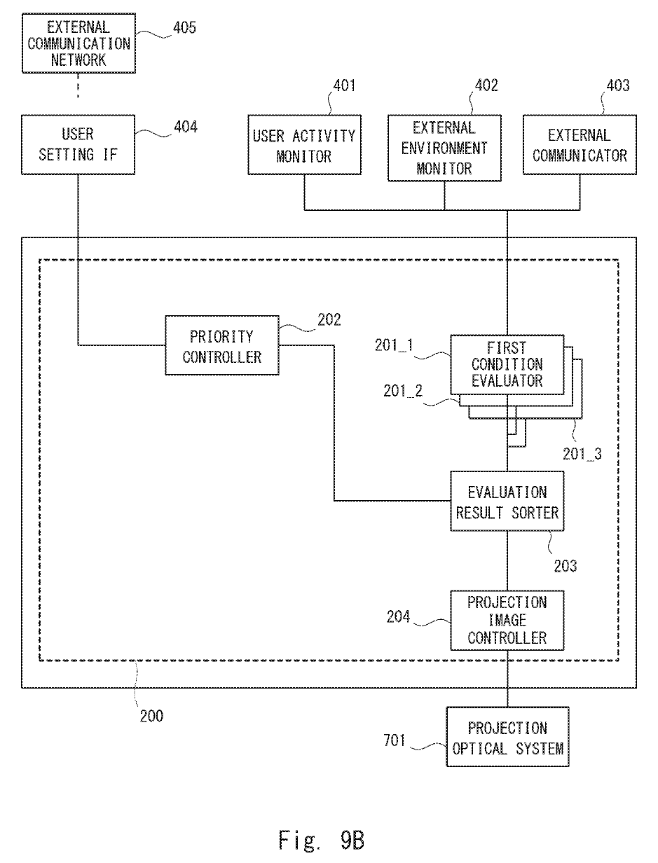

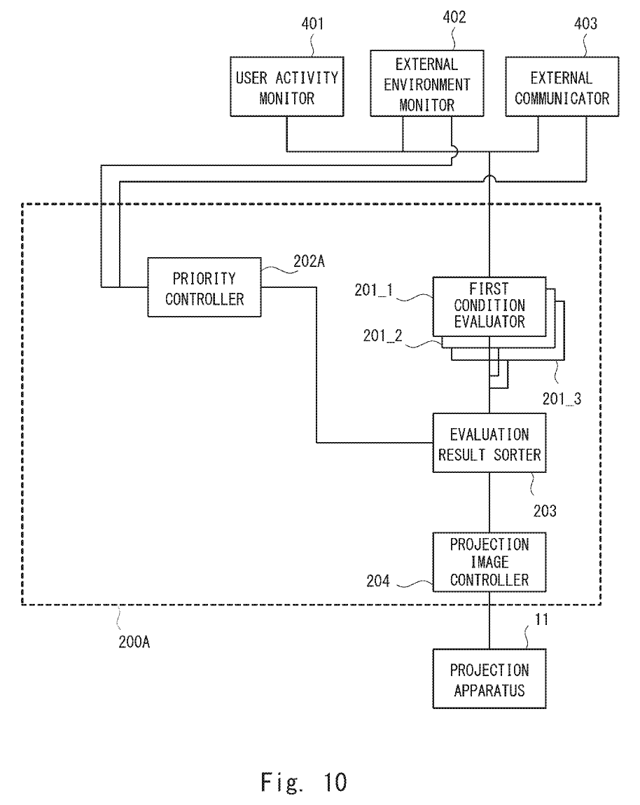

FIG. 9A is a block diagram showing one example of components for projecting information according to a first embodiment. A projection control apparatus 200 shown in FIG. 9A may be included in the controller 100 shown in FIG. 1 or may be an independent apparatus. The projection control apparatus 200 transmits signals to the projection apparatus 11, and controls the projection apparatus 11. The projection control apparatus 200 according to the first embodiment performs processing for determining a projection image to be preferentially projected among a plurality of projection images in Step S3. In the example shown in FIG. 9A, the projection control apparatus 200 includes a first condition evaluator 201_1, a second condition evaluator 201_2, a third condition evaluator 201_3, ∙∙∙ (hereinafter, when the first condition evaluator 201_1, the second condition evaluator 201_2, the third condition evaluator 201_3, ∙∙∙ are not particularly differentiated from one another, they are simply referred to as a "condition evaluator 201"), a priority controller 202, an evaluation result sorter 203, and a projection image controller 204. FIG. 9B is a modification example of the information projection shown in FIG. 9A. The projection control apparatus 200 shown in FIG. 9B is included in the projection apparatus controller 714 shown in FIG. 4A. Alternatively, the projection control apparatus 200 performs partial processing of the projection apparatus controller 714 and controls the projection optical device 701. The projection optical device 701, which may include a display element 7022 in FIG. 4B, may be referred to as an image projector. FIGS. 10-16 are examples in which the projection control apparatus 200 controls the projection apparatus 11, and details thereof will be described. The "XX(er)" herein may be referred to as an "XX unit" or an "XX device".

The condition evaluator 201 evaluates, based on vehicle information, a projection condition for projecting an image. In this embodiment, the condition evaluator 201 acquires vehicle information from a user activity monitor 401, an external environment monitor 402, an external communicator 403, and the like mounted on the vehicle, and evaluates whether or not a predetermined projection condition for projecting a predetermined projection image is satisfied. Specifically, one condition evaluator 201 is used for evaluation processing for one projection condition. That is, the first condition evaluator 201_1 evaluates, based on the acquired vehicle information, whether or not a first projection condition for projecting a first projection image is satisfied, the second condition evaluator 201_2 evaluates, based on the acquired vehicle information, whether or not a second projection condition for projecting a second projection image is satisfied, and the third condition evaluator 201_3 evaluates, based on the acquired vehicle information, whether or not a third projection condition for projecting a third projection image is satisfied. Note that the number of condition evaluators 201, that is, the number of types of the projection images is not limited to the number shown in the drawings.

Note that the user activity monitor 401 includes, for example, a vehicle speed sensor 501, a shift position sensor 502, a steering wheel angle sensor 503, a headlight sensor 504, an engine start sensor 509, vehicle operation switches 510, an acceleration sensor 512, a gyro sensor 513, a vehicle interior camera 520, an audio input device 522, wiper switches 526, and the like shown in FIG. 2. The user activity monitor 401 inputs acquired information to the condition evaluator 201. Alternatively, the user activity monitor 401 generates, based on information input from the vehicle speed sensor 501, the shift position sensor 502, the steering wheel angle sensor 503, the headlight sensor 504, the engine start sensor 509, the vehicle operation switches 510, the acceleration sensor 512, the gyro sensor 513, the vehicle interior camera 520, the audio input device 522, the wipers switches 526, or the like, user activity monitoring information which relates to the user's activity, and inputs the generated user activity monitoring information to the condition evaluator 201.

Further, the external environment monitor 402 includes, for example, an illuminance sensor 505, a chromaticity sensor 506, a distance sensor 507, an infrared sensor 508, a temperature sensor 514, a vehicle exterior camera 521, a humidity sensor 524, a rain sensor 525, a rain sensor 528, a road surface sensor 529, and the like shown in FIG. 2. The external environment monitor 402 inputs the acquired information to the condition evaluator 201. Alternatively, the external environment monitor 402 generates, based on information input from the illuminance sensor 505, the chromaticity sensor 506, the distance sensor 507, the infrared sensor 508, the temperature sensor 514, the vehicle exterior camera 521, the humidity sensor 524, the rain sensor 525, the rain sensor 528, the road surface sensor 529, or the like, external environment information which relates to the environment outside the vehicle, and inputs the generated external environment information to the condition evaluator 201.

Further, the external communicator 403 includes, for example, a communication 511, a road-to-vehicle communication wireless transceiver 515, a vehicle-to-vehicle communication wireless transceiver 516, a terminal-to-vehicle communication wired/wireless communication 517, a GPS receiver 518, a VICS receiver 519, and the like shown in FIG. 2. The external communicator 403 inputs the acquired information to the condition evaluator 201.

Then the condition evaluator 201 evaluates whether or not a predetermined projection condition for projecting a predetermined projection image is satisfied based on the information acquired from the user activity monitor 401, the external environment monitor 402, the external communicator 403, and the like. Specifically, the condition evaluator 201 may evaluate whether or not a predetermined projection condition is satisfied based on whether values included in the information acquired from the user activity monitor 401, the external environment monitor 402, the external communicator 403, and the like exceed or below a predetermined threshold. Further, the condition evaluator 201 may evaluate whether or not a predetermined projection condition for projecting a predetermined projection image is satisfied based on the information acquired from the external environment monitor 402, the external communicator 403, and the like by using a trained machine learning model.

Further, the condition evaluator 201 inputs an evaluation result, which is a result of evaluating whether or not the predetermined projection condition is satisfied, to the evaluation result sorter 203.

The priority controller 202 acquires setting information set through the user setting interface 404 by the user, and sets the priority of a plurality of predetermined projection conditions based on the setting information. Then, the priority controller 202 inputs the priority to the evaluation result sorter 203.

Note that the priority controller 202 may acquire setting information from the external communication network 405, not from the user setting interface 404. For example, the priority controller 202 may acquire setting information set by the OTA technology.

The evaluation result sorter 203 selects, based on the evaluation result acquired from the condition evaluator 201, a predetermined projection condition that has been satisfied. Further, the evaluation result sorter 203 determines, based on the priority input from the priority controller 202, the priority of the predetermined projection conditions that have been satisfied.

Further, the evaluation result sorter 203 inputs the determined priority of the predetermined projection conditions to the projection image controller 204.

The projection image controller 204 controls projection of predetermined projection images based on the priority of the predetermined projection conditions acquired from the evaluation result sorter 203. Specifically, the projection image controller 204 controls the projection apparatus 11 in such a way that projection images are projected in the order of priority. Alternatively, the projection image controller 204 controls the projection apparatus 11 in such a way that only a projection image having a high priority is projected. Alternatively, the projection image controller 204 controls the projection apparatus 11 in such a way that images with higher priorities are projected for longer periods of time. Alternatively, the projection image controller 204 controls the projection apparatus 11 in such a way that images with higher priorities are projected larger. Alternatively, the projection image controller 204 controls the projection apparatus 11 in such a way that images with higher priorities are projected brighter. Alternatively, the projection image controller 204 controls the projection apparatus 11 in such a way that images with higher priorities are projected at shorter flashing cycles. Alternatively, the projection image controller 204 controls the projection apparatus 11 in such a way that images with higher priorities are projected in such a manner that at least one of their characteristics, such as period, size, brightness, or flashing cycle is changed.

That is, when the first projection condition, the second projection condition, and the third projection condition are satisfied and the priority is in the order of the second projection condition, the third projection condition, and the first projection condition, the projection image controller 204 causes the projection apparatus 11 to project images in the order of, for example, the second projection image corresponding to the second projection condition, the third projection image corresponding to the third projection condition, and the first projection image corresponding to the first projection image. Alternatively, when the first projection condition, the second projection condition, and the third projection condition are satisfied and the priority is in the order of the second projection condition, the third projection condition, and the first projection condition, the projection image controller 204 causes the projection apparatus 11 to project, for example, only the second projection image corresponding to the second projection condition. Alternatively, when the first projection condition, the second projection condition, and the third projection condition are satisfied and the priority is in the order of the second projection condition, the third projection condition, and the first projection condition, the projection image controller 204 controls the projection apparatus 11 in such a way, for example, that the second projection image is projected for the longest period of time, the third projection image is projected for the second longest period of time, and the first projection image is projected for the shortest period of time.

Alternatively, when the first projection condition, the second projection condition, and the third projection condition are satisfied and the priority is in the order of the second projection condition, the third projection condition, and the first projection condition, the projection image controller 204 controls the projection apparatus 11 in such a way, for example, that the second projection image is projected to be the largest, the third projection image is projected to be the second largest, and the first projection image is projected to be the smallest. Alternatively, when the first projection condition, the second projection condition, and the third projection condition are satisfied and the priority is in the order of the second projection condition, the third projection condition, and the first projection condition, the projection image controller 204 controls the projection apparatus 11 in such a way, for example, that the second projection image is projected to be the brightest, the third projection image is projected to be the second brightest, and the first projection image is projected to be the darkest. Alternatively, when the first projection condition, the second projection condition, and the third projection condition are satisfied and the priority is in the order of the second projection condition, the third projection condition, and the first projection condition, the projection image controller 204 controls the projection apparatus 11 in such a way, for example, that the second projection image flashes most frequently, the third projection image flashes next most frequently, and the first projection image flashes the least frequently. Alternatively, when the first projection condition, the second projection condition, and the third projection condition are satisfied and the priority is in the order of the second projection condition, the third projection condition, and the first projection condition, the projection image controller 204 controls the projection apparatus 11 in such a way, for example, that the second projection image is projected to flash brighter and more frequently than the other images, the third projection image is projected with the moderate brightness, and the first projection image is projected to be the smallest.

With the projection control apparatus 200 according to the first embodiment, even in a case in which a plurality of predetermined projection conditions for projecting a predetermined projection image are satisfied, the projection apparatus 11 can project a predetermined projection image with the priority based on setting information set by the user or setting information externally set via the external communication network 405. Accordingly, it is possible to project a projection image without causing confusion for the driver. Further, the projection apparatus 11 can project a projection image in accordance with the priority which is based on the user's preference or external (e.g., a manufacturer of the vehicle or the projection apparatus 11) setting. When, for example, the vehicle is used in a snowy region and is equipped with studless tires or when the driver of the vehicle is accustomed to driving on the snow, it is not necessarily important to project a projection image of a road surface freezing warning. In such a case, the priority of the projection condition for projecting the projection image of the road surface freezing warning is lowered by the setting information set by the user, so that it becomes possible to project a projection image with a more appropriate priority.

### Second Embodiment

FIG. 10 is a block diagram showing one example of components for projecting information according to a second embodiment. Description of the components of a projection control apparatus 200A according to the second embodiment that are the same as those of the projection control apparatus 200 according to the first embodiment will be omitted.

The priority controller 202A generates setting information based on information acquired from at least one of the external environment monitor 402 and the external communicator 403, and sets priority of a plurality of predetermined projection conditions based on the setting information. The priority controller 202 then inputs the priority to the evaluation result sorter 203.

When the priority controller 202A acquires information from both the external environment monitor 402 and the external communicator 403, it is determined in advance which one of the setting information which is based on the information acquired from the external environment monitor 402 and the setting information which is based on the information acquired from the external communicator 403 should be prioritized. In this embodiment, setting by the user is not reflected in the priority of the projection images. It is possible that setting information set by the user may contain bias in terms of recognition. When, for example, the driver of the vehicle is accustomed to driving on the snow, it is possible that the user may overestimate his/her driving skills on the snow and lower the priority of the projection condition even when road conditions are beyond his/her skill level, which may cause danger. In this case, it is desirable that the user does not intervene in evaluation of the priority of the projection conditions.

With the projection control apparatus 200A according to the second embodiment, even in a case where a plurality of predetermined projection conditions for projecting a predetermined projection image are satisfied, the projection apparatus 11 can project a predetermined projection image with the priority which is based on setting information set based on information regarding external environment of a vehicle or setting information set based on the information acquired via the external communicator 403. Accordingly, it is possible to project the projection image without causing confusion for the driver. Further, the projection apparatus 11 can project the projection image with the priority which is based on setting depending on the external environment of the vehicle or setting by information acquired from road-to-vehicle communication, vehicle-to-vehicle communication, terminal-to-vehicle communication, Global Positioning System (GPS), VICS, or the like. When, for example, the driver is from abroad and he/she may likely to drive in the wrong way and there is a vehicle in the entrance of a highway from positional information acquired from the GPS, the priority of the projection condition for projecting the projection image warning of the wrong-way driving is raised, whereby it is possible to project the projection image with a more appropriate priority.

### Third Embodimen

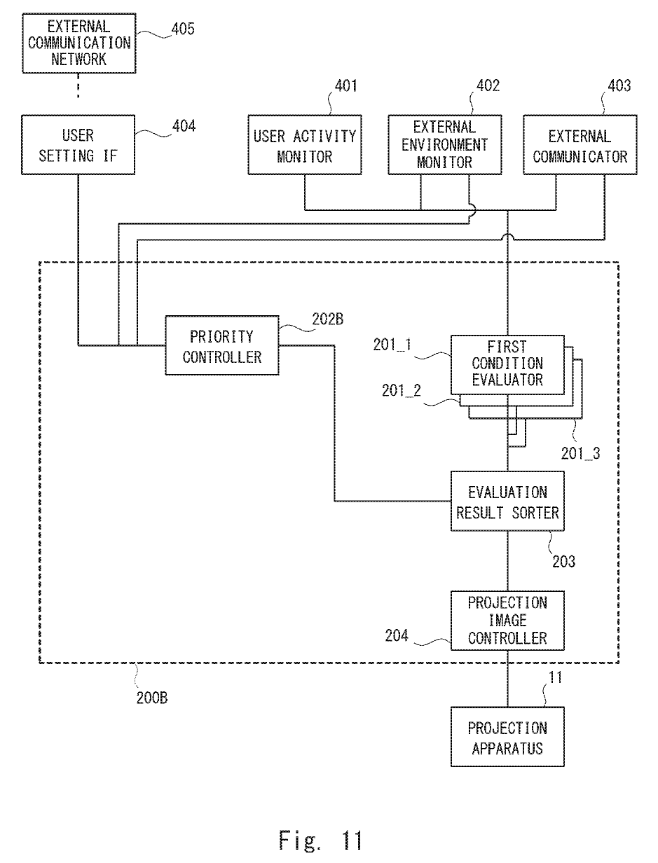

FIG. 11 is a block diagram showing one example of components for projecting information according to a third embodiment. Description of the components of a projection control apparatus 200B according to the third embodiment that are the same as those of the projection control apparatus 200 according to the first embodiment will be omitted.

The priority controller 202B sets priority of a plurality of predetermined projection conditions based on at least one of setting information acquired from the user setting interface 404 and setting information generated based on information acquired from at least one of the external environment monitor 402 and the external communicator 403. Then, the priority controller 202B inputs this priority to the evaluation result sorter 203. Note that the priority controller 202B may acquire setting information from the external communication network 405, not from the user setting interface 404.

Further, when the priority controller 202B acquires information from a plurality of components the user setting interface 404, the external environment monitor 402, and the external communicator 403, it is determined in advance based on which one of setting information acquired from the user setting interface 404, setting information which is based on the information acquired from the external environment monitor 402, and setting information which is based on the information acquired from the external communicator 403 the priority of the plurality of predetermined projection conditions is set. For example, a projection image such as a collision warning or a wrong-way driving warning that immediately affects other vehicles may be set so as to use setting information which is based on the information acquired from the external environment monitor 402 or setting information which is based on the information acquired from the external communicator 403, and a projection image that alerts the driver to his/her driving behavior, such as a road surface freezing warning or a predicted trajectory, may be set so as to use the setting information acquired from the user setting interface 404.

With the projection control apparatus 200B according to the third embodiment, even when a plurality of predetermined projection conditions for projecting a predetermined projection image are satisfied, the projection apparatus 11 can project a predetermined projection image with the priority which is based on setting information set by the user, setting information externally set via the external communication network 405, setting information set based on the information regarding the external environment of the vehicle, or setting information set based on information acquired via the external communicator 403. Accordingly, it is possible to project the projection image without causing confusion for the driver. Further, the projection apparatus 11 can project the projection image with the priority based on user's preference, external (e.g., a manufacturer of the vehicle or the projection apparatus 11) setting, setting based on the external environment of the vehicle, or setting by information acquired from road-to-vehicle communication, vehicle-to-vehicle communication, terminal-to-vehicle communication, Global Positioning System (GPS), VICS, or the like.

### Fourth Embodiment

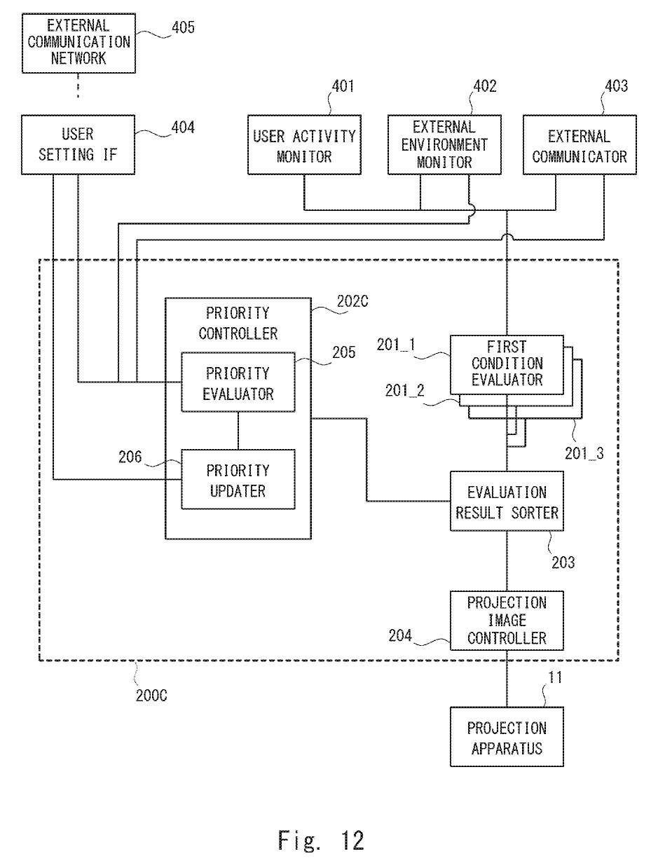

FIG. 12 is a block diagram showing one example of components for projecting information according to a fourth embodiment. Description of the components of a projection control apparatus 200C according to the fourth embodiment that are the same as those of the projection control apparatus 200B according to the third embodiment will be omitted.

The priority controller 202C includes a priority evaluator 205 and a priority updater 206.

The priority evaluator 205 evaluates priority of a plurality of predetermined projection conditions based on at least one of setting information acquired from the user setting interface 404 and setting information generated based on information acquired from at least one of the external environment monitor 402 and the external communicator 403. Further, when the priority evaluator 205 acquires information from a plurality of components of the user setting interface 404, the external environment monitor 402, and the external communicator 403, it is determined in advance based on which one of the setting information acquired from the user setting interface 404, the setting information which is based on the information acquired from the external environment monitor 402, and the setting information which is based on the information acquired from the external communicator 403 the priority of the plurality of predetermined projection conditions is set. Note that the priority evaluator 205 may acquire setting information from the external communication network 405, not from the user setting interface 404.

The priority updater 206 updates, based on update information acquired from the user setting interface 404, the priority of the plurality of predetermined projection conditions evaluated by the priority evaluator 205.

Then, the priority controller 202C inputs the priority of the plurality of predetermined projection conditions evaluated by the priority evaluator 205 to the evaluation result sorter 203. Further, when the priority of the plurality of predetermined projection conditions has been updated by the priority updater 206, the priority controller 202C inputs this updated priority into the evaluation result sorter 203.

For example, the priority evaluator 205 evaluates, based on at least one of setting information acquired from the user setting interface 404 and setting information generated based on information acquired from at least one of the external environment monitor 402 and the external communicator 403, whether the value included in the acquired information exceeds a predetermined threshold or below the predetermined threshold, determines which setting information should be prioritized, and updates the priority by the priority updater 206. As one example, when a road surface freezing warning is displayed based on outside temperature information, if the outside temperature is below setting 1, the setting information acquired from the user setting interface 404 is reflected in the priority. On the other hand, when the outside temperature is below setting 2, which is lower than the setting 1, the priority updater 206 reflects setting information generated based on the information acquired from at least one of the external environment monitor 402 and the external communicator 403 in the priority. Accordingly, when the warning level is low, unnecessary projection images are suppressed taking into account the user's setting. On the other hand, when the warning level is high, a projection image can be displayed.

With the projection control apparatus 200C according to the fourth embodiment, it is possible to achieve effects similar to those obtained in the projection control apparatus 200B according to the third embodiment. Further, with the projection control apparatus 200C according to the fourth embodiment, it is possible to update the priority of the plurality of predetermined projection conditions evaluated by the priority evaluator 205 by the update information acquired from the user setting interface 404. Accordingly, when, for example, priority different from a normal priority is preferable in association with a change in the situation, such as a change in the environment outside the vehicle, or the like, the user can update the priority. It is further possible to update, by the update information acquired from the external communication network 405, the priority of the plurality of predetermined projection conditions evaluated by the priority evaluator 205. Accordingly, it is possible to update, by the OTA technology, for example, the priority of the plurality of predetermined projection conditions evaluated by the priority evaluator 205.

### Fifth Embodimen

FIG. 13 is a block diagram showing one example of components for projecting information according to a fifth embodiment. Description of the components of a projection control apparatus 200D according to the fifth embodiment that are the same as those of the projection control apparatus 200B according to the third embodiment will be omitted.

The projection control apparatus 200D according to the fifth embodiment further includes a pattern generator 207.

The pattern generator 207 acquires pattern setting information set by the user from the user setting interface 404, and generates, based on this pattern setting information, a projection pattern of a predetermined projection image projected based on priority determined by the evaluation result sorter 203. Specifically, the pattern generator 207 generates, based on this pattern setting information, a projection pattern such as a projection position or a projection cycle in accordance with the priority. When, for example, a plurality of predetermined projection conditions for projecting a plurality of projection images have been satisfied, the pattern generator 207 projects, based on this pattern setting information, a projection image having a high priority at the center of the vehicle front road surface display region A11, and generates a projection pattern for projecting a projection image having a low priority onto the left side or the right side of the vehicle front road surface display region A11. Alternatively, the pattern generator 207 generates, based on this pattern setting information, a projection pattern having a projection cycle such that projection images having higher priority are projected for a long time. Then the pattern generator 207 inputs this projection pattern to the projection image controller 204D.

As described above, when a plurality of predetermined projection conditions for projecting a plurality of projection images have been satisfied, a plurality of images may be projected at the same time. In this case, a predefined number of projection images may be projected from the plurality of projection images that have been satisfied. Further, when a plurality of images are projected, these images may be displayed by generating some patterns of images, like in the following examples, in order to display information with an image having a high priority for the driver in an emphasized manner. (Example 1) the image projection position is changed based on the priority, (Example 2) the projection cycle of the image is changed based on the priority, (Example 3) the size of the image is changed based on the priority, (Example 4) the brightness of the image is changed based on the priority, and (Example 5) the flashing cycle of the image is changed based on the priority. A plurality of these examples may be used in combination with each other. Further, for images with the same priority, a specified number of images with the same pattern setting may be projected. Further, if there are images with high priority and high urgency is set in one of these images, only one of these images may be set to be projected without allowing projection of the plurality of images.

Note that the pattern generator 207 may acquire pattern setting information from the external communication network 405, not from the user setting interface 404. For example, the pattern generator 207 may acquire pattern setting information set by the OTA technology. The pattern generator 207 may newly generate a predetermined projection image, or may use an image obtained by changing the size, the brightness, the position, the cycle, or the like of the predetermined image as the predetermined projection image.

The projection image controller 204D controls projection of predetermined projection images based on the priority of predetermined projection conditions acquired from the evaluation result sorter 203. Further, the projection image controller 204D controls the projection apparatus 11 in such a way that the projection image is projected in the projection pattern generated by the pattern generator 207.

With the projection control apparatus 200D according to the fifth embodiment, it is possible to obtain effects similar to those obtained in the projection control apparatus 200B according to the third embodiment. Further, with the projection control apparatus 200D according to the fifth embodiment, it is possible to generate the projection pattern of the projection image based on the pattern setting information acquired from the user setting interface 404. Accordingly, it is possible, for example, for the user to set the projection pattern. Further, it is possible to generate the projection pattern of the projection image based on the pattern setting information acquired from the external communication network 405. Accordingly, it is possible to externally set, for example, the projection pattern by the OTA technology.

### Sixth Embodiment

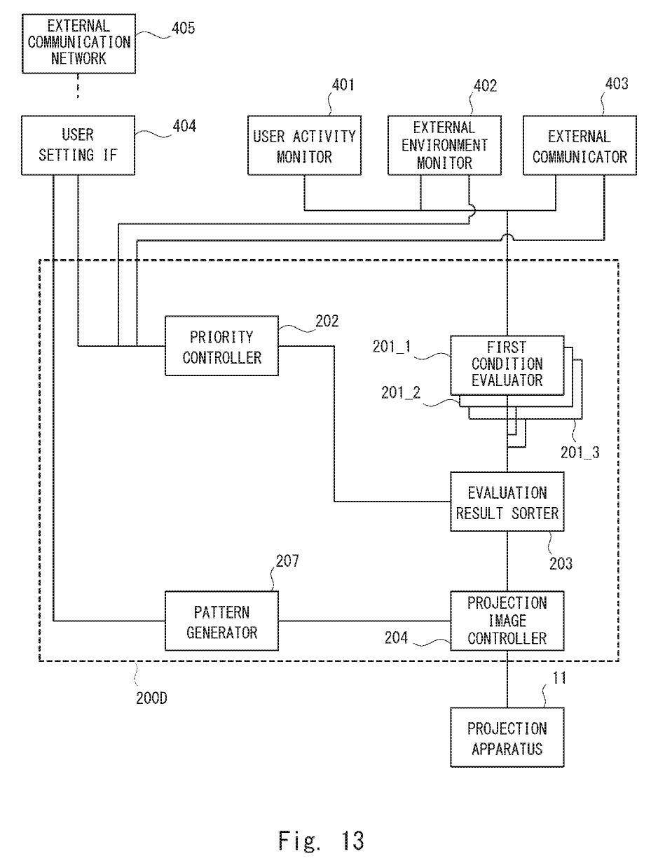

FIG. 14 is a block diagram showing one example of components for projecting information according to a sixth embodiment. Description of the components of a projection control apparatus 200E according to the sixth embodiment that are the same as those of the projection control apparatus 200D according to the fifth embodiment will be omitted.

Like the evaluation result sorter 203, the evaluation result sorter 203E determines, based on the evaluation result acquired from the condition evaluator 201 and priority input from the priority controller 202, the priority of satisfied predetermined projection conditions.

Further, the evaluation result sorter 203E determines, based on the priority input from the priority controller 202, which projection image corresponding to which one of the plurality of predetermined projection conditions should be output from the external information display device as a display image representing the same information. Here, the external information display device includes a vehicle interior image device 12, an external device 25, and an information terminal 26. Examples of the external information display device include, for example, an in-vehicle infotainment system (IVI) such as an HUD, a meter panel, or a center information display (CID). Then, the evaluation result sorter 203E determines, for example, that a projection image corresponding to the projection condition having the highest priority should be output from both the projection apparatus 11 and the external information display device. Further, the evaluation result sorter 203E determines, for example, the projection image (display image) corresponding to the projection condition having the second highest priority should be output from the external information display device.

Further, the evaluation result sorter 203E inputs, to the projection image controller 204, the priority of the predetermined projection condition corresponding to the predetermined projection image determined to be output to the projection apparatus 11. Further, the evaluation result sorter 203E inputs, to the external information display device, the priority of the predetermined projection condition corresponding to the predetermined projection image (display image) determined to be output to the external information display device. While both the projection apparatus 11 and the external information display device can be used as information notification means for the driver, each of them has its own unique advantage. For example, the projection apparatus 11 has an advantage that the driver can visually recognize the projection image as well as the traveling path even in a condition in which the driver is paying close attention to the traveling path while driving. Therefore, when it is monitored, by a driver monitor or the like, that the driver is paying close attention to the traveling path, information having a high priority may be projected by the projection apparatus 11 as a projection image. On the other hand, the external information display device has an advantage that it is unlikely to be influenced by the environment such as road surface conditions or surrounding illuminance. Therefore, when it is determined that sufficient contrast cannot be ensured with projection by the projection apparatus 11 since the surroundings are bright and the user cannot visually recognize the projection image, the image may be projected onto the external information display device.

Like the pattern generator 207, the pattern generator 207E generates, based on the pattern setting information acquired from the user setting interface 404 or the external communication network 405, a projection pattern of a predetermined projection image projected based on the priority determined by the evaluation result sorter 203E. Then, the pattern generator 207E inputs this projection pattern to the projection image controller 204D.

Further, the pattern generator 207E generates a display pattern of a predetermined projection image projected based on the priority determined by the evaluation result sorter 203E for the external information display device. The pattern generator 207E generates, for example, a display pattern in which a display image corresponding to the predetermined projection image is displayed in a predetermined region of the display screen of the external information display device (e.g., an end part on one of the right side, the left side, the upper side, or the lower side of the display screen) for the external information display device. Then, the pattern generator 207E inputs the display pattern to the external information display device.

With the projection control apparatus 200E according to the sixth embodiment, it is possible to achieve effects similar to those of the projection control apparatus 200D according to the fifth embodiment. Further, with the projection control apparatus 200E according to the sixth embodiment, when a plurality of predetermined projection conditions are satisfied, it is possible to select a projection image (display image) output by the external information display device according to the priority. Accordingly, for example, the number of projection images projected by the projection apparatus 11 can be reduced.

Further, the pattern generator 207E generates the display pattern of the projection image for the external information display device. Therefore, for example, a display pattern in which a display image corresponding to the predetermined projection image is displayed in an end part on one of the right side, the left side, the upper side, or the lower side of the display screen of the external information display device may be generated. Accordingly, the external information display device can display the display image so as not to disturb display of information that the external information display device should originally output.

### Seventh Embodiment

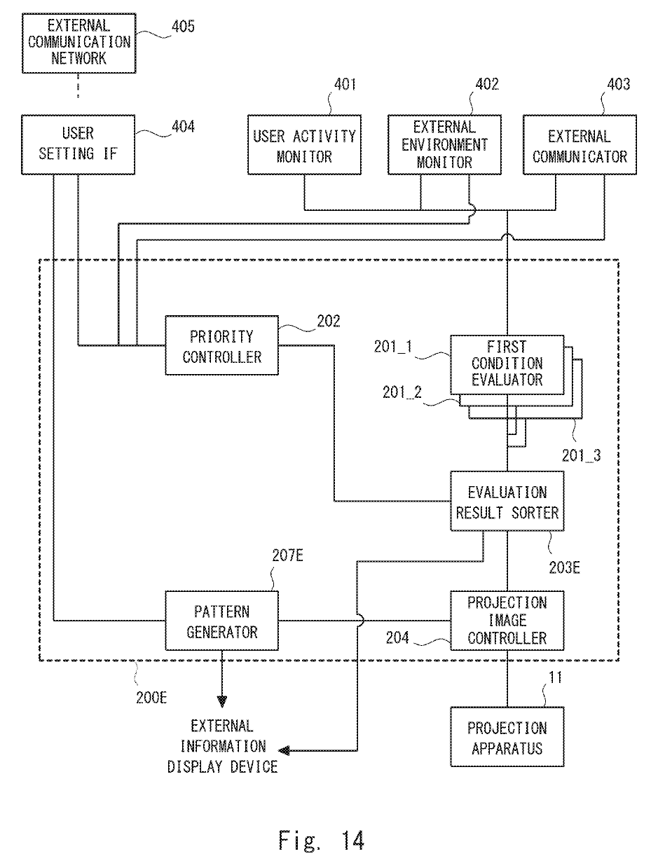

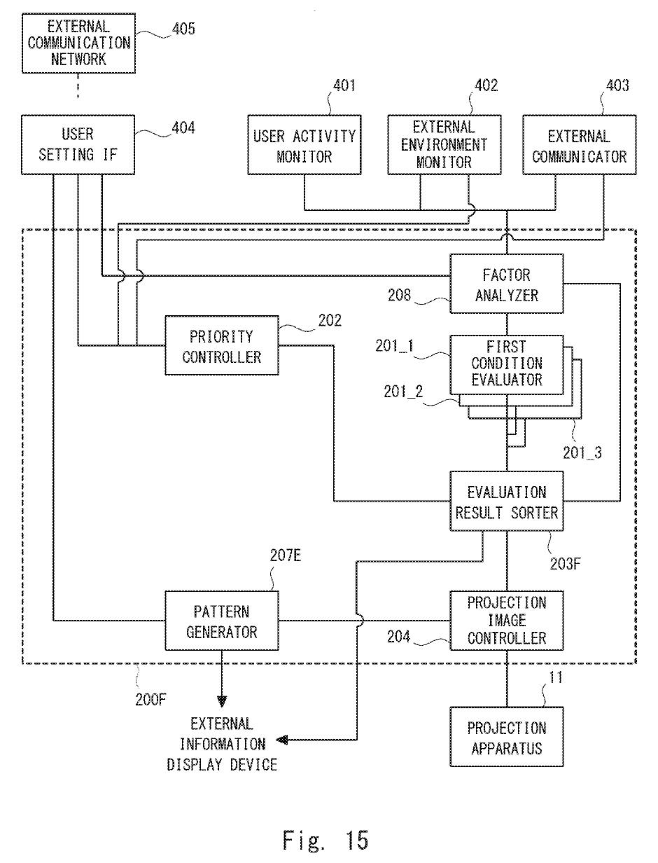

FIG. 15 is a block diagram showing one example of components for projecting information according to a seventh embodiment. Description of the components of a projection control apparatus 200F according to the seventh embodiment that are the same as those of the projection control apparatus 200E according to the sixth embodiment will be omitted.

The projection control apparatus 200F according to the seventh embodiment further includes a factor analyzer 208.

The factor analyzer 208 acquires, from the user setting interface 404, weight setting information regarding degrees of weights to be added to factors for establishing a predetermined projection condition. Note that the factor analyzer 208 may acquire weight setting information from the external communication network 405.

Further, the factor analyzer 208 analyzes, based on weight setting information acquired from the user setting interface 404 or the external communication network 405, weights added to the factors for establishing the predetermined projection condition. Specifically, the factor analyzer 208, which is disposed between the user activity monitor 401, the external environment monitor 402, the external communicator 403, and the condition evaluator 201, analyzes the weights added to the factors for establishing the predetermined projection condition included in vehicle information to be input to the condition evaluator 201 from the user activity monitor 401, the external environment monitor 402, and the external communicator 403.

Then, the factor analyzer 208 inputs results of analyzing the weights added to the factors for establishing the predetermined projection condition to the evaluation result sorter 203F.

Like the evaluation result sorter 203, the evaluation result sorter 203F determines priority of satisfied predetermined projection conditions based on an evaluation result acquired from the condition evaluator 201 and priority input from the priority controller 202.

Further, the evaluation result sorter 203F changes, based on results of analyzing the weights added to the factors for satisfying the predetermined projection conditions which has been acquired from the factor analyzer 208, the determined priority of the predetermined projection conditions.

For example, factors for establishing a projection condition for projecting a projection image of a road surface freezing warning include weather information acquired from the external communicator 403, information obtained by analyzing the road surface image of the vehicle exterior camera 521 acquired from the external environment monitor 402, information output from a sensor that directly detects slippage of a tire, or the like. Then, it is possible that a projection image corresponding to a projection condition that is satisfied by a direct factor such as information output by a sensor that detects slippage of a tire have a higher priority for conveying information to the user than a projection image corresponding to a projection condition that is satisfied by an indirect factor such as weather information or road surface image analysis information. Therefore, weights are added to these factors in accordance with the priority of projection of projection images corresponding to the projection condition that is satisfied by these factors. Then, even when the projection condition is the same, the priority of the projection conditions is changed based on the weights added to the factors that have satisfied this projection condition.

With the projection control apparatus 200F according to the seventh embodiment, it is possible to obtain effects similar to those obtained in the projection control apparatus 200E according to the sixth embodiment. Further, with the projection control apparatus 200F according to the seventh embodiment, even when the projection condition is the same, the priority of the projection condition is changed based on the weights added to the factors that have satisfied the projection condition. Therefore, when a plurality of projection conditions have been satisfied, it is possible to project projection images corresponding to these projection conditions with a more appropriate priority.

### Eighth Embodiment

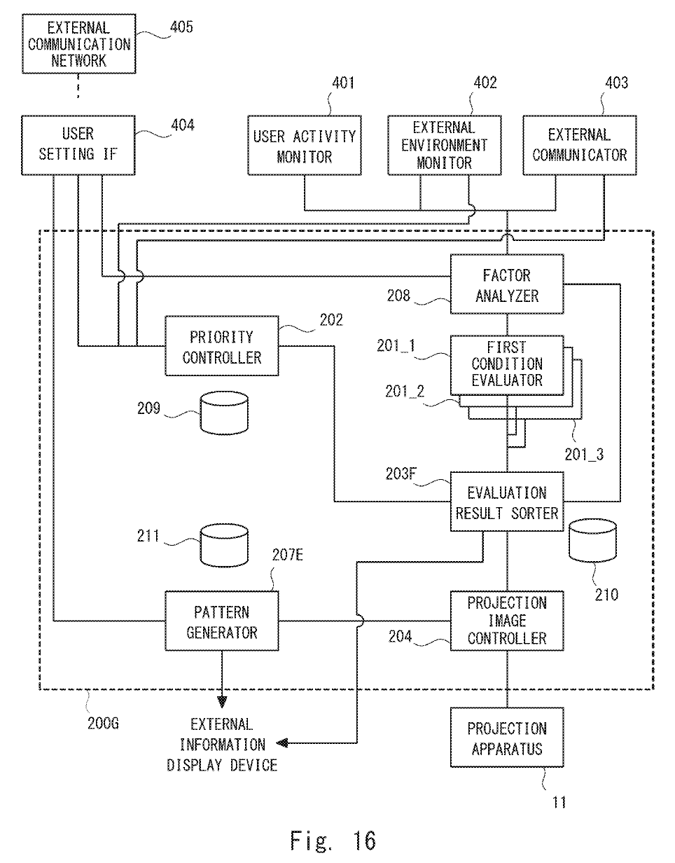

FIG. 16 is a block diagram showing one example of components for projecting information according to an eighth embodiment. Description of the components of a projection control apparatus 200F according to the eighth embodiment that are the same as those of the projection control apparatus 200E according to the seventh embodiment will be omitted.

The projection control apparatus 200F according to the seventh embodiment further includes memories 209, 210, and 211. The memories 209, 210, and 211 are each, for example, a volatile storage device such as a RAM, and are each a storage area for temporarily storing information. Alternatively, the memories 209, 210, and 211 are each a non-volatile storage device such as a ROM, or may be a storage area for storing information non-temporarily.

The memory 209 (first memory) stores results of processing in the priority controller 202. For example, the memory 209 stores priority of a plurality of predetermined projection conditions set by the priority controller 202. The memory 209 may further store a change in the priority of the plurality of predetermined projection conditions set by the priority controller 202.

The memory 210 (second memory) stores results of processing in the evaluation result sorter 203F. For example, the memory 210 stores priority of a plurality of satisfied predetermined projection conditions determined by the evaluation result sorter 203F. Further, the memory 210 may store a change in the priority of the plurality of satisfied predetermined projection conditions determined by the evaluation result sorter 203F.

The memory 211 (third memory) stores results of processing in the pattern generator 207E. The memory 211 stores, for example, a projection pattern or a display pattern generated by the pattern generator 207E.

With the projection control apparatus 200G according to the eighth embodiment, it is possible to achieve effects similar to those of the projection control apparatus 200F according to the seventh embodiment. Further, with the projection control apparatus 200G according to the eighth embodiment, the priority of the plurality of predetermined projection conditions and its changes set by the priority controller 202 are stored in the memory 209. Further, the priority of the plurality of satisfied predetermined projection conditions and its changes determined by the evaluation result sorter 203F are stored in the memory 210. Accordingly, it is possible to correct, for example, a defect of the results of the determination of the priority made by the priority controller 202, which is due to unstableness of the results of monitoring the external environment, based on the priority stored in the memory 209 and its changes. Further, it is possible to correct the defect of the result of determination of the priority of the evaluation result sorter 203F, which is due to unstableness of the result of monitoring the external environment, based on the priority stored in the memory 210 and its changes. Further, the projection pattern or the display pattern generated by the pattern generator 207E is stored in the memory 211. Accordingly, for example, the pattern generator 207E can generate a new projection pattern or display pattern based on the projection pattern or the display pattern stored in the memory 211. The pattern generator 207E can generate, for example, a projection pattern or a display pattern in which the user's preference is reflected.

In the examples shown in FIGS. 9A and 10-16, the projection control apparatus 200 is shown as an independent apparatus or the one that is provided in the controller 100. Further, by including the projection control apparatus 200 in the controller 100, it is expected that the number of parts can be reduced as the number of cables is reduced, as well as the mounting area thereof. Further, by embedding the projection control apparatus 200 in the controller 100 as software, it becomes easy to customize functions. Furthermore, in the example shown in FIG. 9B, by including the projection control apparatus 200 in the projection apparatus 11 and arranging the projection control apparatus 200 in the projection apparatus controller 714, the mounting area can be reduced. Further, by embedding the projection control apparatus 200 in the projection apparatus controller 714 as software, it is possible to reduce the number of parts.

The above embodiments may be combined with each other and a new embodiment may be created. For example, while the fourth embodiment and the fifth embodiment are described as modification examples of the third embodiment, they may be modification examples of embodiments other than the third embodiment. Further, while the sixth embodiment is described as a modification example of the fifth embodiment, it may be a modification example of an embodiment other than the fifth embodiment. Further, while the seventh embodiment is described as a modification example of the sixth embodiment, it may be a modification example of an embodiment other than the sixth embodiment. Further, while the eighth embodiment is described as a modification example of the seventh embodiment, it may be a modification example of an embodiment other than the seventh embodiment.

### Ninth Embodiment

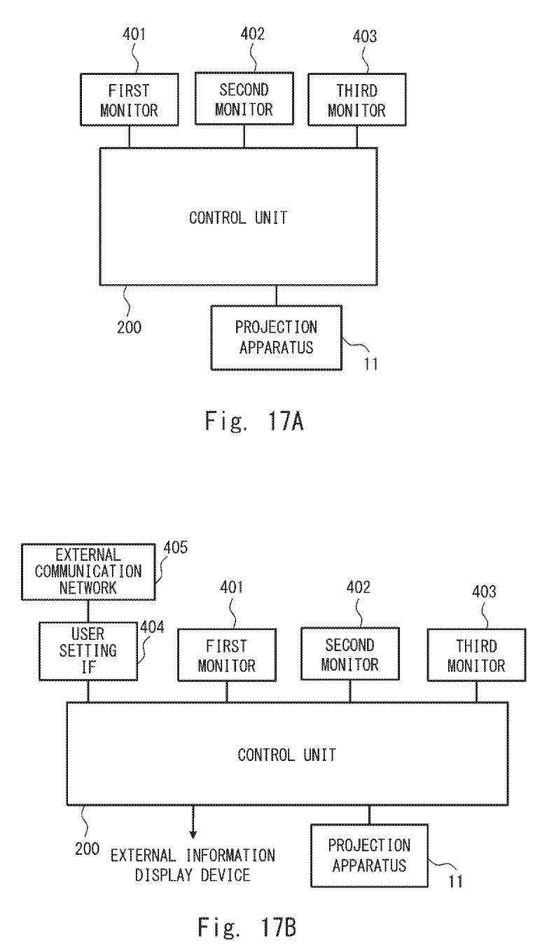

FIG. 17A is a block diagram showing one example of components for projecting information according to a ninth embodiment. The control unit 200 is connected to a plurality of monitors and a projection apparatus 11. The control unit 200 may include a function of the projection control apparatus according to the first to eighth embodiments, that is, the projection control apparatus according to the first to eighth embodiments may be included in the control unit 200. Further, the control unit 200 may be included in the projection apparatus 11 or included in the controller 100 of the vehicle. Since basic processing is the same, a control unit included in the projection apparatus 11 is described as one example in this embodiment. As shown in FIG. 17A, the control unit 200 is connected to the first monitor 401, the second monitor 402, and the third monitor 403, performs evaluation and the like based on the information acquired from each of these monitors, controls projection of an image by the projection apparatus 11 based on the result of determination, and projects the image on the road surface.

The control unit 200 acquires information from the first monitor 401 and/or the second monitor 402 and/or the third monitor 403, and performs evaluation based on the acquired information. Specifically, the control unit 200 evaluates whether or not a projection condition for projecting an image has been satisfied. A projection condition is set in the image that can be projected by the control unit 200 for each image, and the image is projected when the projection condition is satisfied. When the projection condition is not satisfied, the image is not projected, the image may be replaced by another image and this image may be projected, or projection of the image may be ended.

Further, the control unit 200 sets which information from which one of the plurality of monitors should be preferentially projected. When, for example, a projection condition for the image 401A has been satisfied based on the information of the first monitor 401 and a projection condition for the image 402A has been satisfied based on the information of the second monitor 402, the control unit 200 needs to evaluate which image to project. In this case, the order regarding which one of the information acquired from the first monitor 401 or the information acquired from the second monitor 402 should be prioritized is set, the image to be preferentially projected is selected based on the set order, and this image is projected by the projection apparatus 11. The set order may be a preset order, or may be an order change condition by a projection condition. When, for example, the priority of the second monitor 402 is higher than that of the first monitor 401, the image 402A is preferentially projected.

Further, when there are a plurality of images corresponding to each monitor on the assumption that the projection condition for each image is satisfied, the control unit 200 sets the priority of these images. When, for example, there are three images 401A, 401B, and 401C as images corresponding to the information of the first monitor 401 and these three images satisfy a projection condition at the same time, the control unit 200 needs to evaluate which image to project. In such a case, an order for which one of the three images should be preferentially projected is set (the order is set in advance or the order setting is changed), the image to be preferentially projected is selected based on the set order, and this image is projected by the projection apparatus 11. When, for example, the priority of the three images is the image 401C > the image 401B > the image 401A, the image 401C is preferentially projected.

The control unit 200 acquires, for example, information from the first monitor 401, the second monitor 402, and the third monitor 403 for each predetermined time, updates the result of evaluating the projection condition (satisfaction or non-satisfaction) based on the acquired information, updates the priority of which information by which one of the plurality of monitors should be prioritized in real time or appropriately (e.g., a time zone, or from a general road to a highway), updates, as appropriate, the priority of which one of the plurality of images corresponding to each monitor should be preferentially projected, selects, by a combination of them, the image that should be projected with the highest priority among the images for which the priority condition is satisfied at this point, and projects the selected image by the projection apparatus 11. The priority may change, for example, depending on various situations, such as whether the vehicle is stopped or traveling, or whether the road on which the user is driving is a general road or a highway.

### Tenth Embodiment

FIG. 17B is a block diagram showing one example of components for projecting information according to a tenth embodiment. Description of the components shown in the tenth embodiment that are the same as those shown in the ninth embodiment will be omitted. In the tenth embodiment, in addition to acquiring information from the first monitor 401, the second monitor 402, and the third monitor 403, like in the ninth embodiment, setting information set by the user is acquired. Specifically, the control unit 200 provides a user setting interface 404, and acquires setting information set by the user. For example, the control unit 200 receives user's operation via a touch panel installed inside the vehicle and acquires the user's operation as user setting information. In the configuration shown in FIG. 17B, the control unit 200 is connected to an information terminal such as a smartphone owned by the user via the external communication network 405 and acquires information operated by the smartphone as user setting information.

The control unit 200 evaluates a projection condition based on at least one of setting information set by the user, besides the setting conditions described in the ninth embodiment. Further, the control unit 200 sets priority of projection images based on at least one of the setting information set by the user, besides the setting conditions described in the ninth embodiment. Further, the control unit 200 may acquire, for example, information from the first monitor 401, the second monitor 402, and the third monitor 403, for each predetermined time, or may acquire information when the user has newly performed setting. The result of evaluating the projection condition is updated based on the information acquired from the plurality of monitors, the priority of which image corresponding to which information should be preferentially projected is updated, the priority of which one of the plurality of images corresponding to each information piece should be preferentially projected is updated, the image that should be projected with the highest priority is selected among the images for which the priority condition is satisfied at this point by the above combination, and the selected image is projected by the projection apparatus 11. Further, an image for which the projection condition has been satisfied may be displayed and projected on an external information display device that is different from the projection apparatus 11, for example, on an HUD. When, for example, a projection condition for two images has been satisfied at the same time, one of the images may be projected onto the road surface by the projection apparatus 11 and the other one of the images may be projected or displayed by the external information display device. At this time, the image to be projected onto the road surface may be an image for surrounding people or surrounding vehicles, and the image to be projected or displayed on the external information display device may be the image for the user. As one example, the image for pedestrians is projected onto the road surface by the projection apparatus 11, and the image for the driver is displayed by a head-up display as a virtual image.

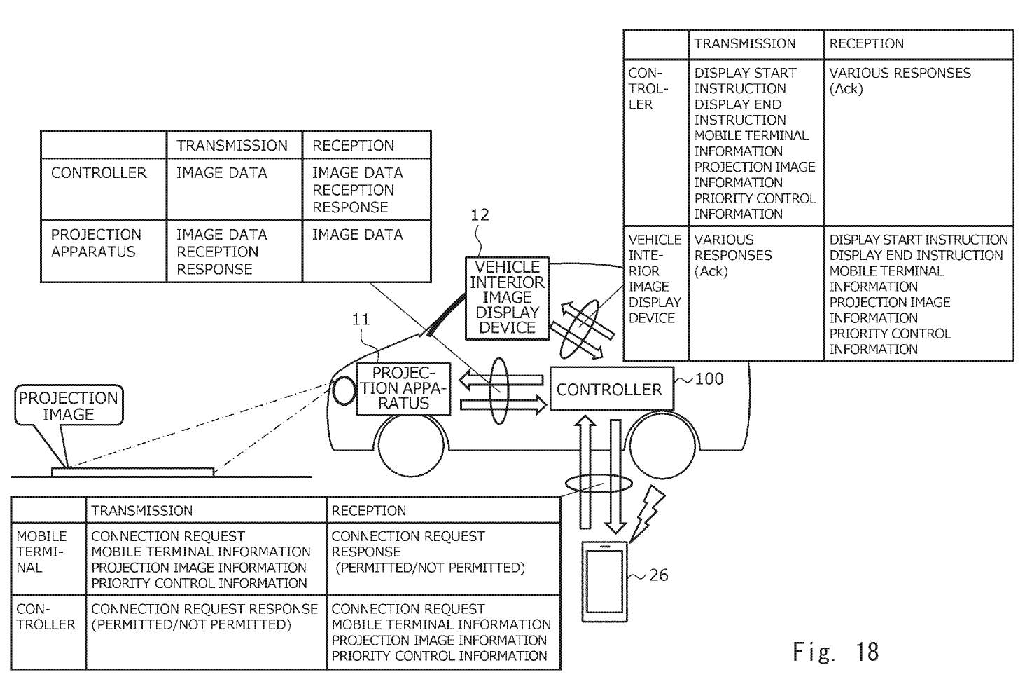

Next, with reference to FIG. 18, one example of processing for setting the priority regarding the projection, which is based on setting information set by the user, will be described. As one example, processing for setting the priority regarding the projection in a case in which the mobile terminal 26 such as a smartphone owned by the user is used as the user setting interface 404 will be described. Further, in the example shown in FIG. 18, the controller 100 is used as the control unit 200. Then, setting information set by the user is input to the controller 100 from the mobile terminal 26. Further, as described above, the controller 100 acquires information from the first monitor 401 to the third monitor 403. When a reception/transmission unit other than the controller 100 is provided, the controller 100 performs control regarding projection based on information acquired by the reception/transmission unit.

In order to allow the user to input the user setting information to the controller 100 via the mobile terminal 26, first, the mobile terminal 26 transmits a connection request and information regarding the mobile terminal (unique information, and the like for specifying the terminal) to the controller 100. Upon receiving the connection request, the controller 100 transmits a response result regarding the connection request (permitted/not permitted) to the mobile terminal 26. After the connection request is permitted, the communication between the mobile terminal 26 and the controller 100 is established, whereby it becomes possible to transmit and receive information related to the user setting information.

The user setting information that the user can set through the mobile terminal 26 includes, for example, priority setting of the first monitor 401, the second monitor 402, and the third monitor 403. For example, while a default priority setting is stored in the non-volatile memory 711, the storage memory 712 (FIG. 4A), or the like, the user can change the priority setting as appropriate via the mobile terminal 26 or the like according to his/her preference. That is, priority control information is transmitted from the mobile terminal 26 to the controller 100, and the controller 100 receives the priority control information, stores the received priority control information in the non-volatile memory 711, the storage memory 712, or the like, and performs control based on the priority control information set by the user. When, for example, the default priority setting is the first monitor 401 > the second monitor 402 > the third monitor 403, if the image 401A corresponding to the first monitor 401 and the image 402A corresponding to the second monitor 402 satisfy the projection condition at the same time, the controller 100 performs control to preferentially project the image 401A based on the priority. When the user has changed the priority to the second monitor 402 > the first monitor 401 > the third monitor 403 via the mobile terminal 26 or the like, if the image 401A and image 402A satisfy the projection condition at the same time, the controller 100 performs control to preferentially project the image 402A based on the priority setting changed by the user or the information received at this time. Specifically, the controller 100 selects and determines the image to be projected based on whether or not the projection condition is satisfied/not satisfied and the priority setting, and transmits image data related to this image to the projection apparatus 11. Then the projection apparatus 11 transmits an image data reception response to the controller 100 and projects the received image data onto the road surface as a projection image.

Another example of the user setting information that the user can set from the mobile terminal 26 includes priority setting among a plurality of images corresponding to each monitor. It is possible that there are a plurality of images corresponding to each of the first monitor 401, the second monitor 402, and the third monitor 403. Here, the plurality of images corresponding to the first monitor 401 are called a first image group, the plurality of images corresponding to the second monitor 402 are called a second image group, and the plurality of images corresponding to the third monitor 403 are called a third image group. While the default priority setting in each image group is stored in the non-volatile memory 711, the storage memory 712, or the like, the user can change the priority setting in each image group as appropriate via the mobile terminal 26 or the like according to his/her preference. When, for example, the default priority setting in the first image group is the image 401A > the image 401B > the image 401C, if the image 401A and the image 401B satisfy the projection condition at the same time, the controller 100 performs control to preferentially project the image 401A based on the priority. When the user has changed the priority to the image 401B > the image 401A > the image 401C via the mobile terminal 26 or the like, if the image 401A and the image 401B satisfy the projection condition at the same time, the controller 100 performs control to preferentially project the image 401B based on the priority setting changed by the user. Specifically, the controller 100 selects and determines the image to be projected based on whether or not the projection condition is satisfied/not satisfied and the priority setting, and transmits image data related to this image to the projection apparatus 11. Then the projection apparatus 11 transmits an image data reception response to the controller 100 and projects the received image data onto the road surface as a projection image.

The user can set the priority as stated above and change the setting according to his/her preference in such a way that information that he/she particularly wants to know while driving is preferentially displayed. The user may be able to directly select an image that he/she wants projected. In this case, the user selects, from the mobile terminal 26, the image that he/she wants projected and transmits this information to the controller 100 as projection image information, and the controller 100 evaluates whether or not a projection condition for the projection image is satisfied. When the projection condition is satisfied, the projection image is projected onto the road surface by the projection apparatus 11.

Further, the controller 100 can cause information to be displayed on the vehicle interior image display device 12 as well. The vehicle interior image display device 12 may be, for example, an HUD or the like, other than a display inside the vehicle. When information is displayed on the vehicle interior image display device 12, the controller 100 transmits a display start instruction to the vehicle interior image display device 12. Further, when the display is ended, the controller 100 transmits a display end instruction. The controller 100 transmits, to the vehicle interior image display device 12, for example, as mobile terminal information, information indicating which mobile terminal 26 has established communication with the controller 100, projection image information, which is a result of selecting an image that the user wants projected, setting information of the priority set by the user (in the drawings, priority control information), or the like, and the vehicle interior image display device 12 displays these information items.

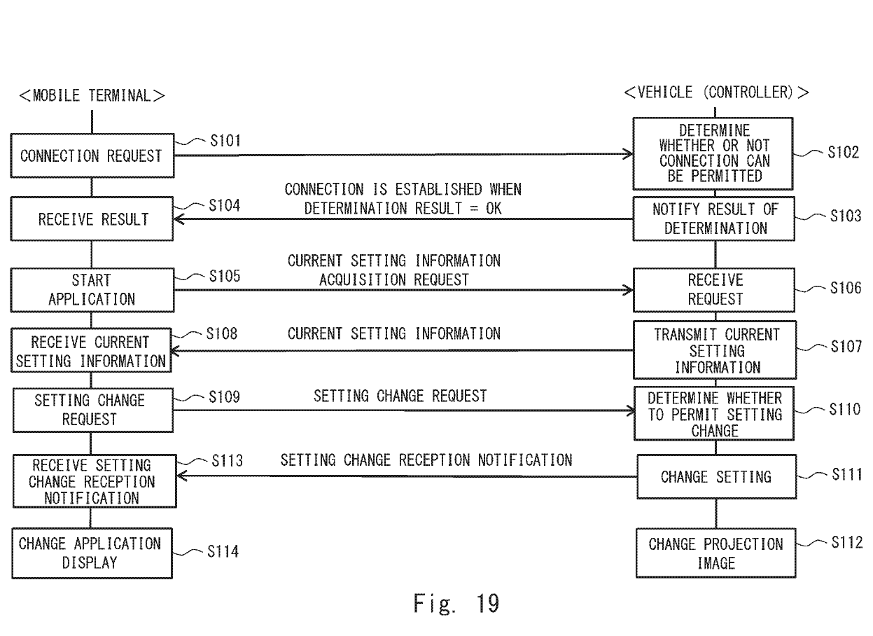

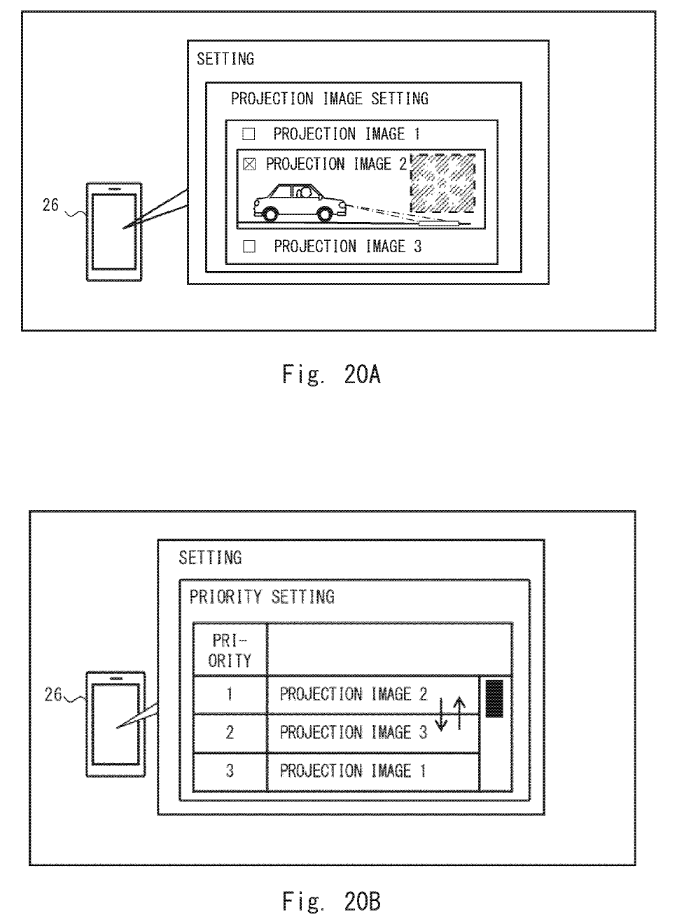

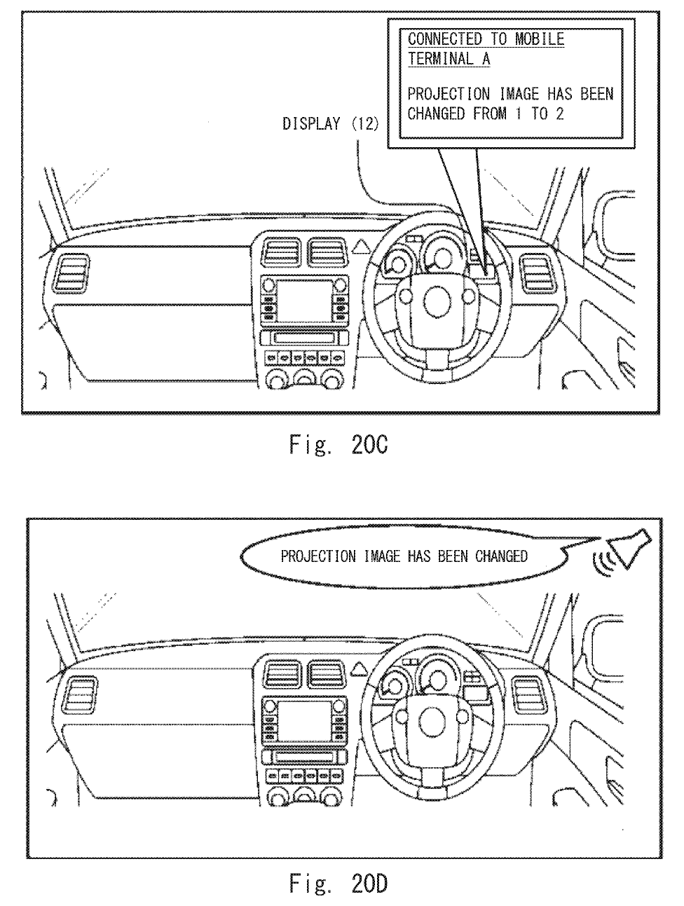

Next, with reference to FIGS. 19 and 20, processing for connecting the vehicle (controller 100) to the mobile terminal 26 and processing for changing the projection image will be described. First, as shown in FIG. 19, the mobile terminal 26 transmits a "connection request" to the controller 100 (Step S101), and the controller 100 determines whether or not the connection can be permitted (Step S102). Specifically, the mobile terminal 26 transmits "information regarding the mobile terminal" along with a "connection request" to the controller 100. The controller 100 allows connection when, for example, it determines that the mobile terminal that has transmitted the connection request is the mobile terminal that the user (driver) owns, and rejects the connection when the mobile terminal that has transmitted the connection request is a mobile terminal owned by a person other than the user or it is an unknown mobile terminal or when the above request is a request from the user's mobile terminal but the user is driving (or during a driving operation). Further, when, for example, the projection apparatus 11 is projecting a projection image, the controller 100 may temporarily store a connection request in a memory or the like, and permit the connection after the elapse of a predetermined period of time. Alternatively, the controller 100 may permit the connection after it becomes ready to change the projection image, such as a timing after projection of the projection image by the projection apparatus 11 is ended. Further, when the terminal is an unknown mobile terminal, the information may be displayed for the user via the vehicle interior image display device 12 or the like and the user may be caused to select whether to permit the connection with the mobile terminal that has sent the connection request. After the user permits the connection, for example, information on the mobile terminal is stored in the non-volatile memory 711, the storage memory 712, or the like, and this terminal is treated as a known, registered terminal in the subsequent operations.

Next, the controller 100 notifies the mobile terminal 26 of the result of determination (Step S103). Specifically, when it is determined, in Step S102, that the connection should be permitted, the controller 100 establishes the connection with the mobile terminal 26 and transmits a notification indicating that the connection has been permitted to the mobile terminal 26. On the other hand, when it is determined, in Step S102, that the connection should not be permitted, the controller 100 does not establish connection with the mobile terminal 26, and a notification indicating that the connection is not permitted to the mobile terminal 26.

Next, the mobile terminal 26 receives the result of determination from the controller 100 (Step S104). When the mobile terminal 26 has received, in Step S104, a notification indicating that the connection has been permitted, the mobile terminal 26 starts an application for setting or changing the projection image or the priority (Step S105). Then, as a result of the processing for starting the application, the mobile terminal 26 transmits a current setting information acquisition request to the controller 100.

Next, after the controller 100 receives the "current setting information acquisition request" from the mobile terminal 26 (Step S106), the controller 100 transmits current setting information such as priority control information of the first monitor 401, the second monitor 402, and the third monitor 403, and priority control information regarding which image is to be prioritized among each of the first image group, the second image group, and the third image group to the mobile terminal 26 (Step S107).

Next, after the mobile terminal 26 receives the current setting information from the controller 100 (Step S108), the mobile terminal 26 displays the received current setting information on the screen of the application. The user (e.g., driver) performs, on the application, for example, an operation for changing the projection image or an operation for changing the priority setting of the image to be projected. The mobile terminal 26 receives the user's operation and transmits the content of the setting change which is based on the user's operation to the controller 100 as a setting change request (Step S109). After the controller 100 receives the setting change request from the mobile terminal 26, the controller 100 determines whether to permit the setting change (Step S110).

When the setting change is permitted in Step S110, the controller 100 changes setting based on the requested setting information (Step S111) and transmits a setting change reception notification to the mobile terminal 26. After the mobile terminal 26 receives the setting change reception notification (Step S113), the mobile terminal 26 changes the application display screen based on the changed setting (Step S114). Further, the controller 100 of the vehicle performs control regarding projection which is based on the changed setting (Step S112).

FIGS. 20A, 20B, 20C, and 20D show specific examples. FIG. 20A is one of examples of a setting change application screen performed by the mobile terminal 26, from which it can be seen that a projection image 2 is currently selected, what kind of pattern this projection image has, and that a projection image 1 and a projection image 3 can also be selected. When the user performs an operation of switching the selection to the projection image 1 on this screen, the screen display is also changed and the pattern of the projection image 1 is displayed. The pattern of the projection image may be displayed in a still image, or a state in which the image is projected from the headlights 13 of the vehicle may be displayed in a moving image/animation. The user arbitrarily selects projection image setting on the above screen, the selected information is transmitted to the vehicle (controller 100) as a setting change request (Step S109), and the image is projected by the projection apparatus 11 when the setting change is permitted and the projection condition for the projection image has been satisfied. Further, when the projection image has been changed, the result of the change may be output to a display such as the display device 12 inside the vehicle (FIG. 20C), may be output as a voice inside the vehicle (FIG. 20D), and it is general to perform at least one of display or voice.

FIG. 20B is another example of the setting change application screen performed by the mobile terminal 26, and shows a screen for changing the priority setting of the projection image. FIG. 20B shows a scene for switching (changing) the priority setting of the projection images (priority setting of projection images in an image group corresponding to a monitor) from the order of the projection image 2 > the projection image 3 > the projection image 1, which corresponds to the current setting, based on a user's operation on the application in such a way that the priority of the projection image 2 and the projection image 3 is switched (changed). After a request for changing the priority setting due to the above operation is permitted by the controller 100, the setting information stored in the non-volatile memory 711, the storage memory 712, or the like is updated, and the display on the application screen is also updated. Further, results of changing the priority setting are also output by at least one of the display such as a display device 12 inside the vehicle, which is a form similar to that shown in FIG. 20C, or voice inside the vehicle, which is a form similar to that shown in FIG. 20D.

Processing for determining Projection Condition, Processing for Setting Priority of Projection Conditions, Processing for determining Priority of Images

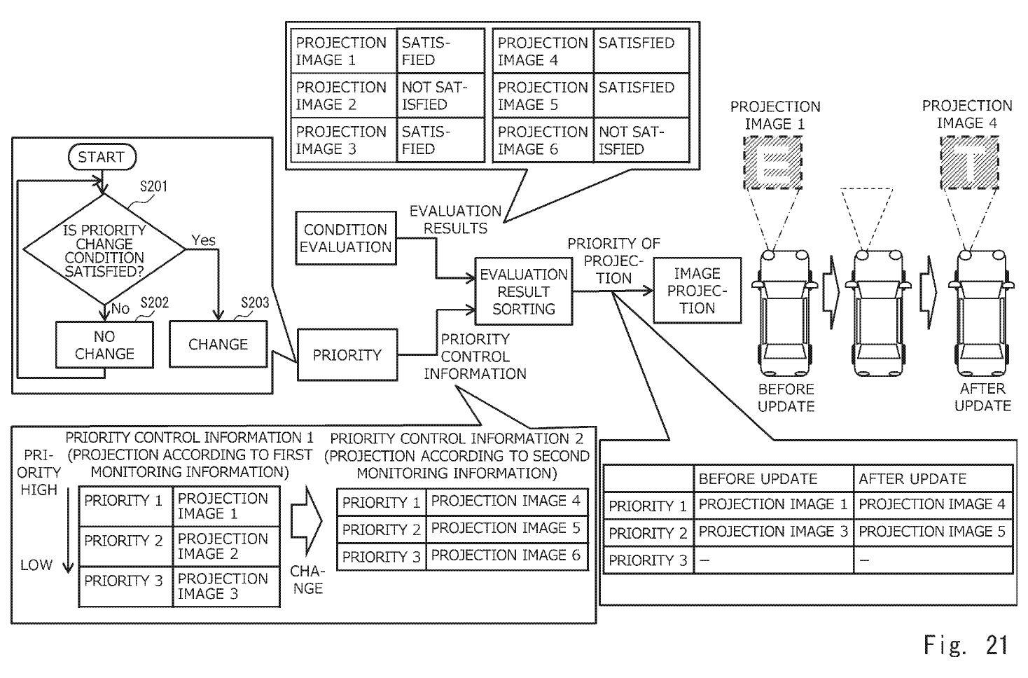

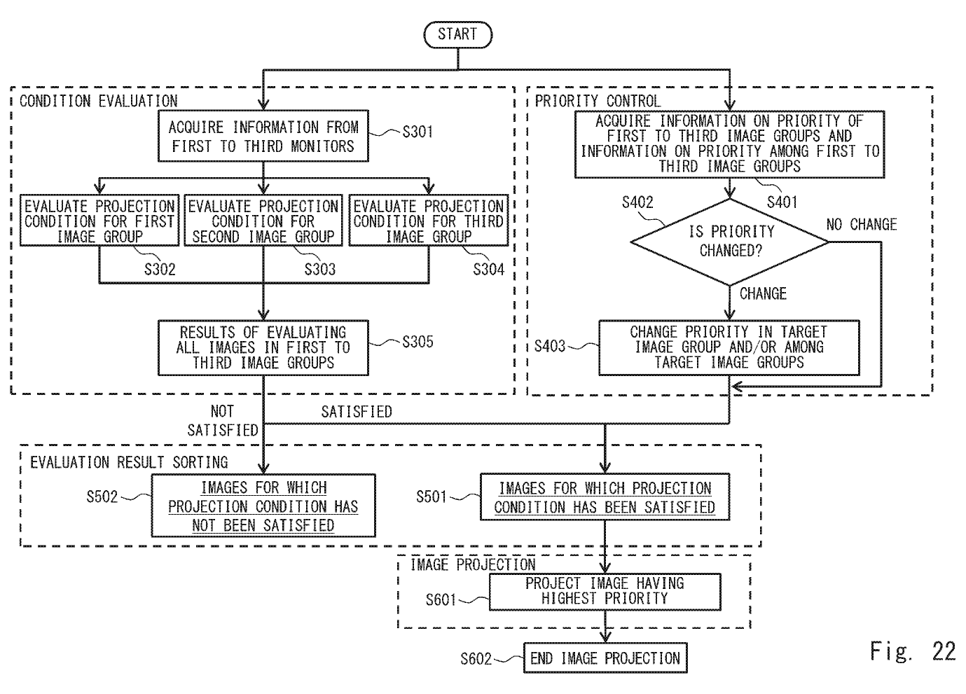

Next, with reference to FIGS. 21 and 22, a series of processing for selecting and determining the projection image will be described. Evaluation results are sorted based on a result of evaluating conditions and priority control information, an image for which the projection condition has been satisfied and which has the highest priority is selected as a projection image, and this image is projected by the projection apparatus 11. First, in the example of FIG. 21, it is evaluated whether or not the projection condition has been satisfied for projection images 1-6, and the results of the evaluation show that the projection condition is set for the projection image 1, the projection image 3, the projection image 4, and the projection image 5, whereas the projection condition is not satisfied for the projection image 2 and the projection image 6. Various examples can be considered regarding which one of the projection image 1, the projection image 3, the projection image 4, and the projection image 5 for which the projection condition has been satisfied should be selected as a projection image. In this embodiment, the projection image is selected based on priority control information.

In the example shown in FIG. 21, priority control information 1 is set as the priority control information. The priority control information 1 is setting for preferentially displaying an image corresponding to information acquired from the first monitor 401 (hereinafter, this information will be referred to as "first monitoring information"), and the priority of the projection image 1, the projection image 2, and the projection image 3, which are images corresponding to the first monitor 401, is set in such a way that the projection image 1 > the projection image 2 > the projection image 3. In evaluation result sorting processing, based on the evaluation results and the priority control information, sorting is performed for images (the projection image 1 and the projection image 3) corresponding to the priority control information 1 set as the priority control information among the images for which the projection condition has been satisfied (the projection image 1, the projection image 3, the projection image 4, and the projection image 5), and the priority 1 is given to the projection image 1, and the priority 2 is given to the projection image 3. The controller 100 projects the projection image 1 (in FIG. 21, an image like "E") onto the road surface based on the priority.

Whether the projection condition is satisfied or not, which image corresponding to information from which monitor should be preferentially projected, and which image in an image group corresponding to each monitor should be preferentially projected change in real time. Therefore, the evaluation of the projection condition and the evaluation of the priority change condition are performed, for example, repeatedly for each predetermined time.

FIG. 21 shows an example in which the priority has been changed although results of evaluating the projection condition are not changed. That is, FIG. 21 shows an example of a case in which the priority change condition is satisfied (Step S201; Yes) in a flow of checking the priority change condition, and the controller 100 changes the priority. On the other hand, when the priority change condition is not satisfied (Step S201; No), the controller 100 does not change the priority of projection conditions (Step S202), and the process returns to the start of this processing.

In the example shown in FIG. 21, the priority regarding which image corresponding to information from which monitor should be projected is changed from the monitor 1 to the monitor 2. Specifically, before the change, the priority of the projection image 1, the projection image 2, and the projection image 3 in accordance with the first monitor information is set as priority control information 1. On the other hand, after the change, as priority control information 2, the priority of the projection image 4, the projection image 5, and the projection image 6 in accordance with the second monitor information is set, and the priority 1 is given to the projection image 4, the priority 2 is given to the projection image 5, and the priority 3 is given to the projection image 6.

Since the priority has been changed, evaluation results are sorted again. Based on the evaluation results (no change in the example shown in FIG. 21) and the changed priority control information, of the images for which the projection condition has been satisfied (the projection image 1, the projection image 3, the projection image 4, the projection image 5), the images (projection image 4, the projection image 5) corresponding to the priority control information 2 set as the priority control information are sorted, and the priority 1 is given to the projection image 4 and the priority 2 is given to the projection image 5. The controller 100 ends projection of the projection image 1 and projects the projection image 4 (in FIG. 21, the image like "T") onto the road surface based on the priority after the update. In this manner, the controller 100 projects the image having the highest priority for which the projection condition has been satisfied at this point depending on the situation that constantly changes.

FIG. 22 shows a flowchart for describing one example until the image to be projected is determined and projected. The evaluation result sorting is performed (S501-S502) from the condition evaluation (S301-S305) and the priority control (S401-S403), and the image projection is performed (S601-S602). First, as shown in FIG. 22, in the processing for determining the projection condition (the "condition evaluation" shown in FIG. 22), the controller 100 acquires first monitoring information to third monitoring information from the first monitor 401 to the third monitor 403 (Step S301). The flowchart shown in FIG. 22 will be described using the processing performed by the controller 100 as one example.

Next, the controller 100 evaluates a projection condition for the first image group corresponding to the first monitoring information (Step S302), evaluates a projection condition for the second image group corresponding to the second monitoring information (Step S303), and evaluates a projection condition for the third image group corresponding to the third monitoring information (Step S304). Then, the controller 100 creates, based on the evaluation result in Step S302, the evaluation result in Step S303, and the evaluation result in Step S304, a table or the like which shows whether all the images included in the first to third image groups satisfy the projection condition (satisfied) or do not satisfy the projection condition (not satisfied) (Step S305). Note that the evaluation processing in Step S302, the evaluation processing in Step S303, and the evaluation processing in Step S304 may be performed in parallel.

Further, as shown in FIG. 22, the controller 100 performs priority control in parallel to condition evaluation. In the processing for setting the priority ("priority control" shown in FIG. 22), first, information regarding the priority among the first to third image groups at this point is acquired, and information on the priority of the plurality of images included in the first image group, the priority of the plurality of images included in the second image group, and the priority of the plurality of images included in the third image group are acquired (Step S401).

Next, the controller 100 determines, based on whether or not a predetermined priority change condition is satisfied, whether or not to change at least one of the priority among the first to third image groups and the priority of a plurality of images in each of the first to third image groups (Step S402). Note that the predetermined priority change condition will be described later.

When the controller 100 determines, in Step S402, that the priority among the first to third image groups and the priority of a plurality of images included in each of the first to third image groups will not be changed (Step S402; no change), the process goes to processing for determining the priority ("evaluation result sorting" shown in FIG. 22).

When the controller 100 determines, in Step S402, that at least one of the priority among the first to third image groups and the priority of a plurality of images included in each of the first to third image groups will be changed (Step S402; change), the controller 100 changes (updates), based on first monitoring information to third monitoring information and user setting information, at least one of the priority among the first to third image groups and the priority of a plurality of images included in each of the first to third image groups (Step S403), and the process goes to evaluation result sorting.

Next, the controller 100 evaluates, in evaluation result sorting, based on the condition evaluation result and the priority control, the priority of the projection images for which the projection condition has been satisfied and performs sorting (Step S501).

Next, the projection apparatus 11 projects the image having the highest priority among the images for which the projection condition has been satisfied in the processing in Step S501 (Step S601). Then, after a time during which this image should be projected has passed, the projection apparatus 11 ends the projection of this image (Step S602). Note that, after the controller 100 has selected and determined the image projected in Step S501, the controller 100 proceeds to Steps S601 and S602 and at the same time returns to the top of the flow, where the controller 100 performs processing in accordance with the flow from Step S301 and Step S401. By performing processing for selecting and determining the image to be projected next (evaluation N+1) during the image projection (Step S601) at this time of evaluation (evaluation N), image projection in the evaluation N+1 can be started immediately after the image projection in the evaluation N is ended in Step S602. That is, control is performed in such a way that the process flow in FIG. 22 is performed in parallel during the image projection in the evaluation N, so that the processing to S601 in the evaluation N+1 is ended.

Projection images for which the projection condition has not been satisfied will not be considered as candidates for image projection for the time of evaluation (N, for example, the first evaluation or the second evaluation). However, information acquired from each monitor to evaluate the projection condition, or in other words, the vehicle, the driver, and the surrounding conditions may constantly change, and satisfaction and non-satisfaction of the projection condition also change. Therefore, for the images for which the projection condition has not been satisfied, the process returns from Step S502 to Step S301, and the processing of Steps S301 to S305 is performed, where it is evaluated whether or not the projection condition is satisfied. It is possible that even the projection images for which the projection condition is not satisfied at this time of evaluation (evaluation N) may become the target to be sorted as candidates for the image projection (Step S501) at the next time of evaluation (evaluation N+1) as the projection condition is satisfied.

Note that the operation after the image projection by the projection apparatus 11 is ended in Step S602 may be changed in accordance with the situation or the setting. When, for example, a vehicle is traveling on a road such as a general road where there are many parts that require caution and many changes in situations, after projection of the image by the projection apparatus 11 is ended in Step S602, the process may return to the top of the flowchart shown in FIG. 22, where the projection images may be sorted. In this case, the condition evaluation, the priority control, and the sorting are performed again, whereby the image that should be projected with the highest priority at this point is projected depending on the change in the situation. On the other hand, when the vehicle is traveling in an area such as a national expressway where there is little change in the situation, after the projection of the image by the projection apparatus 11 is ended in Step S602, the process may return to the middle of the flowchart shown in FIG. 22, for example, before Steps S501 and Step S502, where the projection images may be sorted. In this case, the condition evaluation and the priority control are not performed again. Therefore, the priority of the projection image having the second highest priority in the last evaluation (the first image having the highest priority is projected in Step S601) is moved up, and this image is projected as the image having the highest order in S601.

Further, when there are a plurality of (e.g., two) projection conditions for a certain image, this image may be included, for example, in both the first image group and the second image group. In this case, whether the image satisfies the plurality of projection conditions is evaluated based on both of corresponding first monitoring information and second monitoring information. Further, when the plurality of projection conditions have different priority, the priority of projection condition that is higher than the other one may be employed to evaluate the priority of the images. Further, the priority of an image with more projection conditions may be made higher than the priority of an image with fewer projection conditions.

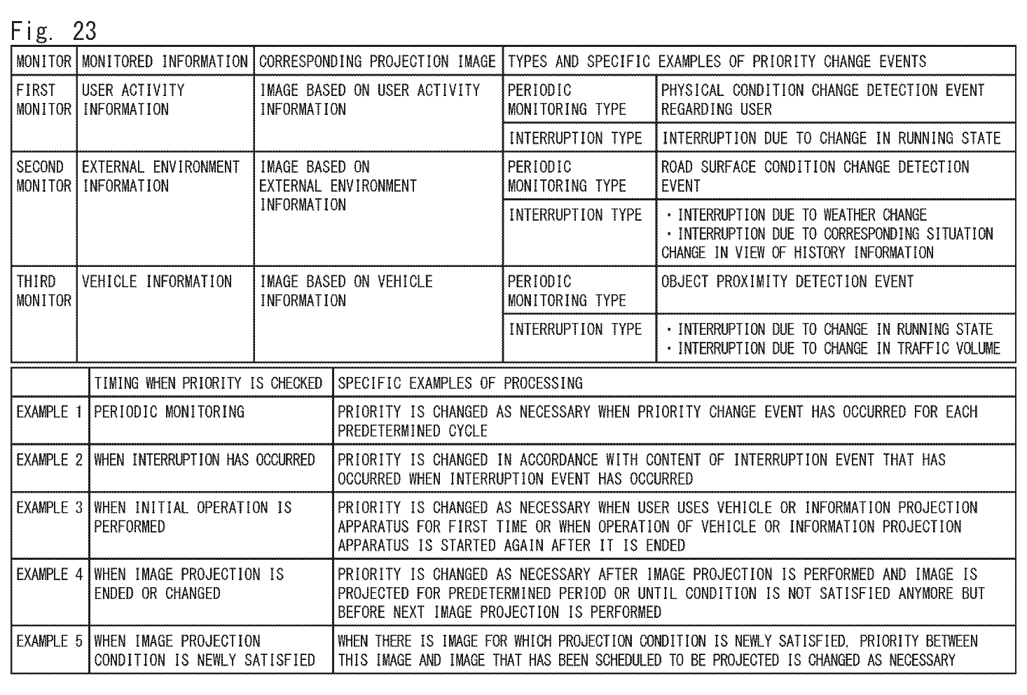

Next, with reference to the upper diagram of FIG. 23, information monitored by the first monitor 401 to the third monitor 403, the corresponding projection image, types and specific examples of priority change events that occur by monitoring by the first monitor 401 to the third monitor 403 will be described. Note that the example shown in the upper diagram of FIG. 23 is merely one example, and information monitored by the first monitor 401 to the third monitor 403, the corresponding projection image, and types and specific examples of the priority change events are not limited to them.

As shown in FIG. 23, the first monitor 401 monitors, for example, user activity information (this is also called "user activity monitoring information"). Further, a projection image corresponding to the first monitor 401 is an image based on user activity information. Further, the types of the priority change events of the first monitor 401 include a "periodic monitoring type" and an "interruption type". Further, specific examples of events of the "periodic monitoring type" of the first monitor 401 include "physical condition change detection event regarding user". The target of monitoring is not limited to a change in the physical condition (e.g., the heart rate increases or decreases), and may also be a change in the user's activity (e.g., an increase or decrease in the frequency of blinking). Specific examples of the events of the "interruption type" include "interruption due to a change in the running state". When, for example, swaying of the vehicle whose magnitude is equal to or greater than a predetermined magnitude has been detected, the priority of the image which is based on the user activity information is increased and an image to alert the user is projected for the user.

Further, the second monitor 402 monitors, for example, external environment information. Further, a projection image corresponding to the second monitor 402 is an image based on the external environment information. Further, types of the priority change events of the second monitor 402 include a "periodic monitoring type" and an "interruption type". Further, specific examples of events of the "periodic monitoring type" of the second monitor 402 include a "road surface condition change detection event". When, for example, a change in the condition of the road surface is monitored at a predetermined cycle and a change in the road surface temperature, ice, or the like is detected, the priority of the image which is based on external environment information is made high, and an image to alert the user is projected for the user. Specific examples of the events of the "interruption type" include "interruption due to a weather change" and "interruption due to corresponding situation change in view of history information". Further, the "history information" is information regarding vehicle travel history or the like. For example, a database or the like that accumulates the history or the like of the own vehicle and/or other vehicles that they have approached, for example, an accident prone area is referred to, and an image to alert the user is projected for the user when the vehicle approaches the accident prone point.

Further, the third monitor 403 monitors, for example, vehicle information. Further, a projection image corresponding to the third monitor 403 is an image based on the vehicle information. Further, the types of priority change events of the third monitor 403 include a "periodic monitoring type" and an "interruption type". Further, specific examples of the events of the "periodic monitoring type" of the third monitor 403 include an "object proximity detection event". Specific examples of the events of the "interruption type" include "interruption due to a change in the running state" and "interruption due to a change in the traffic volume".

Next, with reference to the lower diagram of FIG. 23, the timing when the priority is checked and specific examples of processing for changing the priority will be described. Note that the example shown in the lower diagram of FIG. 23 is merely one example, and the timing when the priority is checked and the specific example of the processing for changing the priority are not limited thereto.

In Example 1 shown in FIG. 23, the timing when the priority is checked is periodic monitoring. In this example, it is checked whether or not there is a priority change event for each predetermined cycle, and the priority is changed when the priority change event has occurred. Targets of events for periodic monitoring include, for example, a user activity event by a first monitor, an external environment event by a second monitor, and a vehicle event by a third monitor.

Further, in Example 2, the timing when the priority is checked is when an interruption has occurred. In this example, the priority is changed in accordance with the content of the interruption event that has occurred at the time when the interruption event has occurred. The interruption event is, for example, an event of an interruption type by the first monitor, the second monitor, and the third monitor.

Further, in Example 3, the timing when the priority is checked is when an initial operation is performed. In this example, when the user uses the vehicle or the information projection apparatus for the first time or when the operation of the vehicle or the information projection apparatus is started again after it is temporarily ended, the priority is changed as necessary or the priority is set when it has not yet been set at the time of, for example, an initial operation, is performed.

Further, in Example 4, the timing when the priority is checked is when image projection is ended or changed. In this example, the priority is checked after image projection is performed and the image is projected for a predetermined period or until the condition is not satisfied anymore but before the next image projection is performed, and the priority is changed as necessary. For example, the priority is checked when the image to be project next is selected/determined after the projection of the projection image 1 is ended, and the image having the highest priority among the images for which the projection condition is satisfied at this point is projected next.

Further, in Example 5, the timing when the priority is checked is when an image projection condition is newly satisfied. It is evaluated whether or not the projection condition is satisfied at a predetermined cycle, and when the result of the evaluation shows that there is an image for which the projection condition is newly satisfied, the priority is changed as necessary between the image for which the projection condition is newly satisfied and the image that has been scheduled to be projected next (that is, an image having the second highest priority after the image that is being projected and for which a projection condition is also satisfied).

That is, the "predetermined priority change condition" in Step S201 in FIG. 21 and Step S402 in FIG. 22 is, for example, "whether the priority needs to be changed when a priority change event has occurred for each predetermined cycle", "whether the priority needs to be changed when an interruption event has occurred", "whether the priority needs to be changed when the user uses the vehicle or the information projection apparatus for the first time or when the operation of the vehicle or the information projection apparatus is started again after it is stopped", "whether the priority needs to be changed after image projection is performed and the image is projected for a predetermined period or until when the condition is not satisfied anymore but before the next image projection is performed", and "whether or not the priority needs to be changed when there is an image for which the projection condition is newly satisfied" as shown in FIG. 23.

Then, when, for example, the priority change event is a "periodic monitoring type", it is preferable that the priority of the corresponding projection image be sorted to the highest level and then this image be immediately projected onto the projection apparatus 11. On the other hand, when, for example, the priority change event is an "interruption type", it may not be strictly required to project the corresponding projection image in real time, Therefore, in this case, the priority of the projection images may be sorted in such a way that projection of the projection image is performed after the elapse of a predetermined period of time or projection of the projection image is performed after projection of another projection image is ended.

Specifically, when a priority change event of the "periodic monitoring type" has occurred by monitoring by the first monitor 401 and the change in the first monitoring information is large, the priority of the corresponding projection image is immediately changed to the highest level. When, for example, it is detected that the user's (driver's) physical condition is poor, the priority of the corresponding projection image is immediately changed to the highest level. When the change in the physical condition is great, the priority may be greatly changed (e.g., the priority 5 is changed to the priority 1). On the other hand, when the change in the physical condition is small, the priority may be slightly changed (e.g., the priority 5 is changed to the priority 4). Further, the monitoring cycle may be shortened when a sign of poor physical condition is detected, and the monitoring cycle may be made back to its original cycle after any sign of improvement is detected.

Further, when a priority change event of the "interruption type" has occurred by monitoring by the first monitor 401, the priority of the corresponding image is changed. Specifically, it is monitored whether a priority change event of the "interruption type" has occurred for each predetermined time. It is evaluated, for example, whether to change the priority when the running state is changed. Specifically, when a priority change event has occurred since the running state of the vehicle has changed from the traveling state to the stopped state or from the stopped state to the traveling state, the priority of the image corresponding to the first monitor 401 may be raised or lowered. Further, when a priority change event has occurred since the vehicle has entered a national expressway or a general road, the priority of the image corresponding to the first monitor 401 may be raised or lowered.

Further, when a change in the condition of the road surface is periodically monitored by the second monitor 402 and a change in the condition of the road surface such as ice, wetness, or the like on the road surface has been detected, a priority change event of the "periodic monitoring type" occurs, and the priority of the projection image for notifying the user of the road surface conditions is immediately changed to the highest level. Further, when a weather change has been monitored by the second monitor 402 and a weather change such as rain starting or wind picking up has been detected, a priority change event of the "interruption type" occurs and the priority of the projection image for informing the user of the weather change is changed. These changes in the weather may be periodically monitored. However, these changes in the weather are changes that are monitored at intervals longer than those in the periodic monitoring and are manageable, allowing sufficient time to address them. Therefore, when these weather changes have been detected, processing for changing the priority, which is performed when a priority change event of the "interruption type" has occurred, is performed.

Further, when the vehicle is traveling on a road that the user rarely drives on, a priority change event of the "interruption type" may occur by monitoring by the second monitor 402, and the priority of the projection image corresponding to the second monitor 402 may be raised. When this road is a road that the user drives for the first time, it is required for the user to pay attention and stay alert. Therefore, the priority of the projection image corresponding to the second monitor 402 is raised, and even when a slight change occurs in the external environment, a projection image for notifying the user of this change is projected. Further, when the vehicle travels near an accident prone area, a priority change event of the "interruption type" may occur by monitoring by the second monitor 402, and the priority of the projection image corresponding to the second monitor 402 may be temporarily raised as the vehicle comes closer to the above accident prone area.

Further, as a periodic monitoring event by the third monitor 403, for example, it is monitored, at a predetermined cycle, whether or not there is an object that has approached the own vehicle near the oven vehicle (the own vehicle has approached a stationary object such as a wall, the own vehicle has approached a non-stationary object such as a person or another vehicle, and/or a person or another vehicle has approached the own vehicle). After the event is detected, the priority of the image which is based on vehicle information is made high. Further, as the event of the interruption type by the third monitor 403, for example, when it is detected that the traveling speed of the own vehicle has changed from a high speed (80 km/h or higher) to a low speed (30 km/h or less) or it is detected that the traffic volume (people, vehicles, or the like near the own vehicle) has changed, an image in accordance with the change is projected.

Types of Priority Change Event and Specific Example of Processing for changing Priority

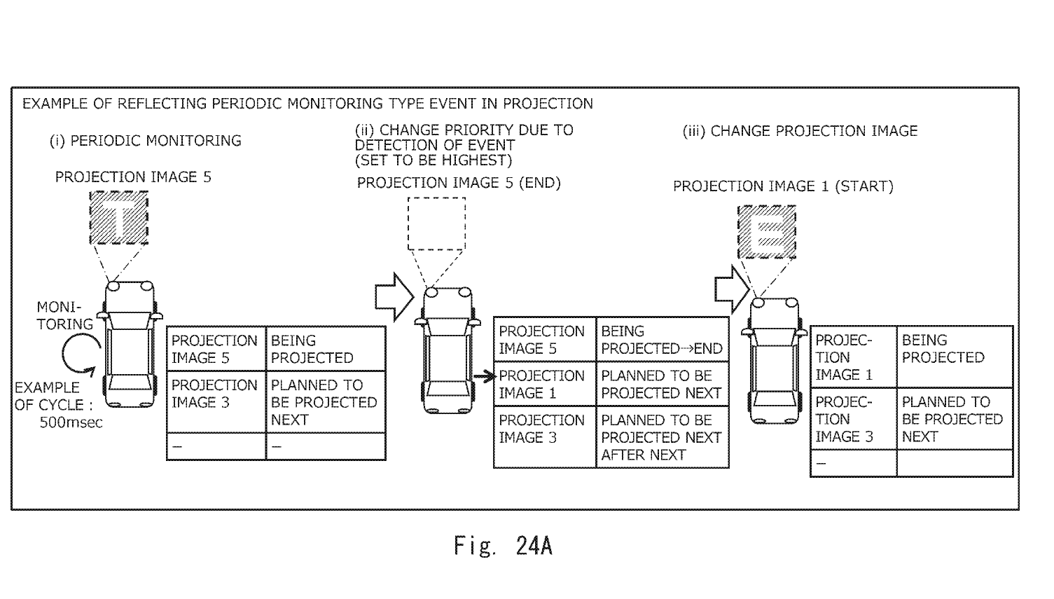

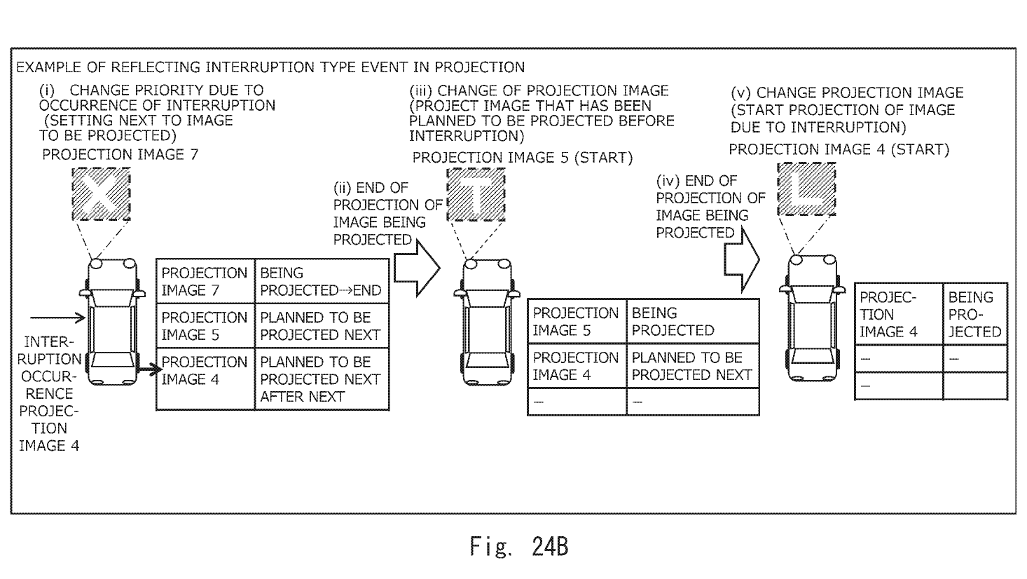

Next, with reference to FIGS. 24A and 24B, types of the priority change events and one example of processing for changing priority will be described. FIG. 24A shows processing for changing priority when a priority change event of a "periodic monitoring type" has occurred, and FIG. 24B shows processing for changing priority when a priority change event of an "interruption type" has occurred.

As shown in FIG. 24A, first, in the first monitor 401 to the third monitor 403, monitoring is performed, for example, at a cycle of 500 msec. At the time of (i) of FIG. 24A, a projection condition for the projection image 3 and the projection image 5 is satisfied, and the projection image 5 having a higher priority is projected from the projection apparatus 11 of the vehicle. Next, (ii) of FIG. 24A shows a case in which a priority change event has occurred as a result of continuing monitoring at a cycle of 500 msec. In the example of (ii) of FIG. 24A, the priority of the projection image 1 corresponding to the occurred event is sorted to the highest level. Accordingly, after the projection of the projection image 5 is ended, the projection image 1 is selected as an image to be projected next in place of the projection image 3 which has been planned to be projected next. The projection apparatus 11 ends projection of the projection image 5 after projecting, for example, the projection image 5 for a predetermined period of time. For example, nothing is projected onto the road surface temporarily. As shown in (iii) of FIG. 24A, for example, after the elapse of a predetermined interval time since the projection of the projection image 5 is ended, projection of the projection image 1 having the highest priority is started (the projection image 5 is changed to the projection image 1). In this manner, the priority of the projection image corresponding to the periodic monitoring event may be set high so that it can be projected shortly after the condition is satisfied (occurrence of event), whereby it is possible to perform preferable control. Further, at this time, the top candidate to be projected next is the projection image 3. When the projection of the projection image 1 is ended and the image to be project next is determined, the projection image 3 is projected if the projection condition for the projection image 3 is satisfied and there is no change in the priority. However, another projection image may be projected when the projection condition has not been satisfied or when the priority has been changed.

(i) of FIG. 24B shows a case in which an event of the interruption type has occurred while the projection image 7 is being projected. When an interruption event occurs, it is evaluated whether or not it is required to change the priority at the timing when the event has occurred. In the example of (i) of FIG. 24B, the image corresponding to the occurred interruption type event is the projection image 4, and the priority of the projection image 4, which is a new candidate for projection, and an image which has already been the candidate for projection is evaluated. Specifically, the priority of the image to be projected next to the projection image 7, or in other words, the projection image 5 having the highest priority among the images for which the projection condition is satisfied except for the projection image 7, and the projection image 4 corresponding to the event that has newly occurred is set. In the example shown in FIG. 24B, the priority is set in such a way that the projection image 5 > the projection image 4 ((i) of FIG. 24B). After the projection image 7 which has been projected is projected for a predetermined period of time ((ii) of FIG. 24B), the projection image 5 that has the second highest priority is projected after the elapse of, for example, a predetermined interval time ((iii) of FIG. 24B). Then, after the projection image 5 is projected for a predetermined period of time ((iv) of FIG. 24B), the projection image 4 having the next highest priority starts to be projected ((v) of FIG. 24B). In this manner, the projection image corresponding to the interruption type event may not often be projected immediately after the condition is satisfied (occurrence of interruption) (in the example shown in the drawing, even after the condition is satisfied, the projection image 5 is projected first and then the projection image 4 corresponding to the interruption type event is projected). In order to achieve this, the priority of the image corresponding to the interruption type event is set to be relatively low, so that preferable control can be achieved. As a matter of course, there are situations other than those stated above. Therefore, it is desirable that the priority can be set and changed as appropriate in accordance with the user's preference or the like.

Specific Examples of Interval Setting when Projection Image is changed

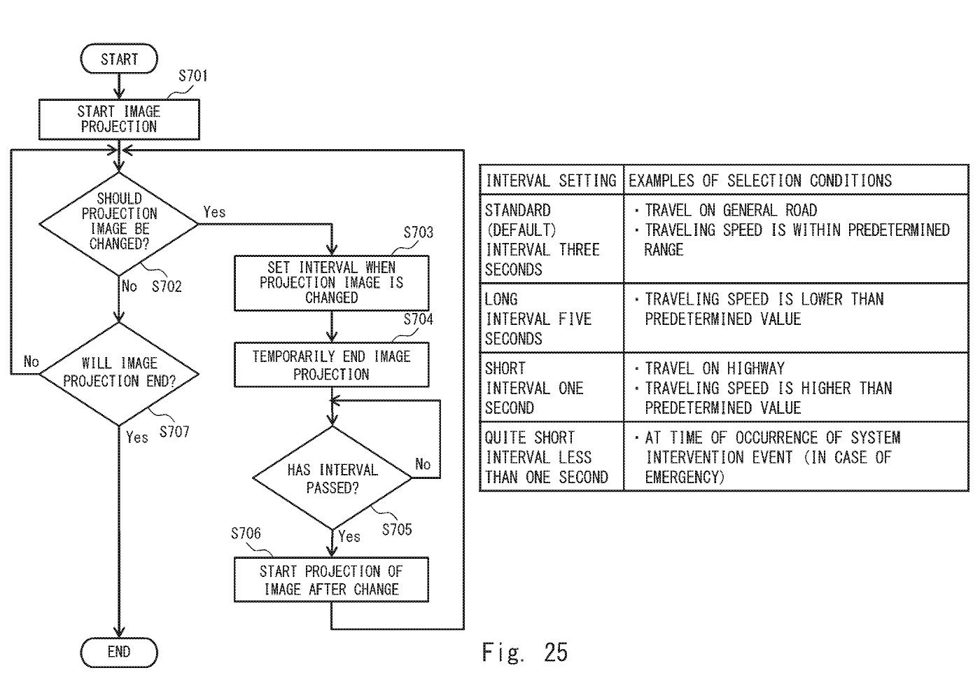

Next, with reference to FIG. 25, specific examples of interval setting when a projection image is changed will be described. When, for example, the projection image of the projection apparatus 11 is changed from the projection image 5 to the projection image 1, after projection of the projection image 5 is ended, the projection image 1 starts to be projected after an interval of a predetermined length. This interval may not be always constant and may vary depending on the situation. As shown on the right side of FIG. 25, when the vehicle is traveling on a general road or the traveling speed of the vehicle is within a predetermined speed range, the interval is set to the standard (default), which is, for example, three seconds. Further, when the traveling speed of the vehicle is lower than a predetermined speed, the interval may be set, for example, to five seconds, which is greater than the length of the standard interval. Further, when the vehicle is traveling on a national expressway or the traveling speed of the vehicle is higher than a predetermined speed, the interval may be set, for example, to one second, which is shorter than the length of the standard interval. In this manner, the interval may be flexibly adjusted depending on conditions such as a driving status. Further, for example, in a case of emergency, such as when an abnormality has occurred in the vehicle or the external environment (at the time of occurrence of a system intervention event), it is preferable that the interval be set, for example, to less than one second so that information that is required for the user can be quickly presented.

As described above, the interval should be dynamically controlled in accordance with conditions such as the traveling speed, and it is preferable that the interval be set in such a way that optimal information is provided for the user. FIG. 25 shows, on the left side, a flowchart showing one example of a timing of setting an interval when a projection image is changed. As shown on the left side of FIG. 25, when, for example, projection of the projection image 5 is started by the projection apparatus 11, the controller 100 starts a timer for counting the projection time (Step S701). Next, the controller 100 determines whether or not to change the projection image (Step S702).

When the controller determines, in Step S702, that the projection image should be changed (Step S702; Yes), the controller 100 sets the interval when the projection image is changed (Step S703). For example, the controller 100 sets the interval based on criteria shown on the right side of FIG. 25.

Next, after the projection apparatus 11 finishes projecting the projection image 5 for a predetermined time, the projection apparatus 11 ends projection of the projection image 5. The image projection onto the road surface is temporarily ended and nothing is projected onto the road surface (Step S704). After the projection of the projection image 5 is ended, the controller 100 starts a timer for measuring the interval time, and determines, by the timer, whether or not the interval time set in Step S703 has passed (Step S705).

When the controller 100 determines, in Step S705, that the interval time set in Step S703 has not passed (Step S705; No), the controller 100 repeats the processing of Step S705. When the controller 100 determines, in Step S705, that the interval time set in Step S703 has passed (Step S705; Yes), the projection apparatus 11 starts projection of the projection image after the change, for example, projection of the projection image 1 (Step S706), and the controller 100 returns to the processing in Step S702.

When the controller 100 determines, in Step S702, that the projection image will not be changed, or in other words, when there is no image to be projected next to the projection image 5 that is currently being projected (such as a case where there is no image for which the projection condition has been satisfied) (Step S702; No), the process moves to Step S707, where the controller 100 determines whether or not to end the projection of the projection image 5.

When it is determined, in Step S707, that, for example, the time during which the projection image 5 should be projected has not passed and the controller 100 has determined that the projection of the projection image 5 will not be ended, that is, projection of the projection image 5 should be continued until a predetermined projection time elapses (Step S707; No), the controller 100 returns to the processing in Step S702. When it is determined, in Step S707, that, for example, the time during which the projection image 5 should be projected has passed and the controller 100 determines that the projection of the projection image 5 will be ended (Step S707; Yes), this processing is ended. After that, when, for example, a projection condition for a projection image is newly satisfied, processing of this flow is performed from Step S701, where the image is projected. The time during which each projection image should be projected, that is, the time during which projection of the projection image continues until a predetermined projection time elapses may be referred to as a projection duration time.

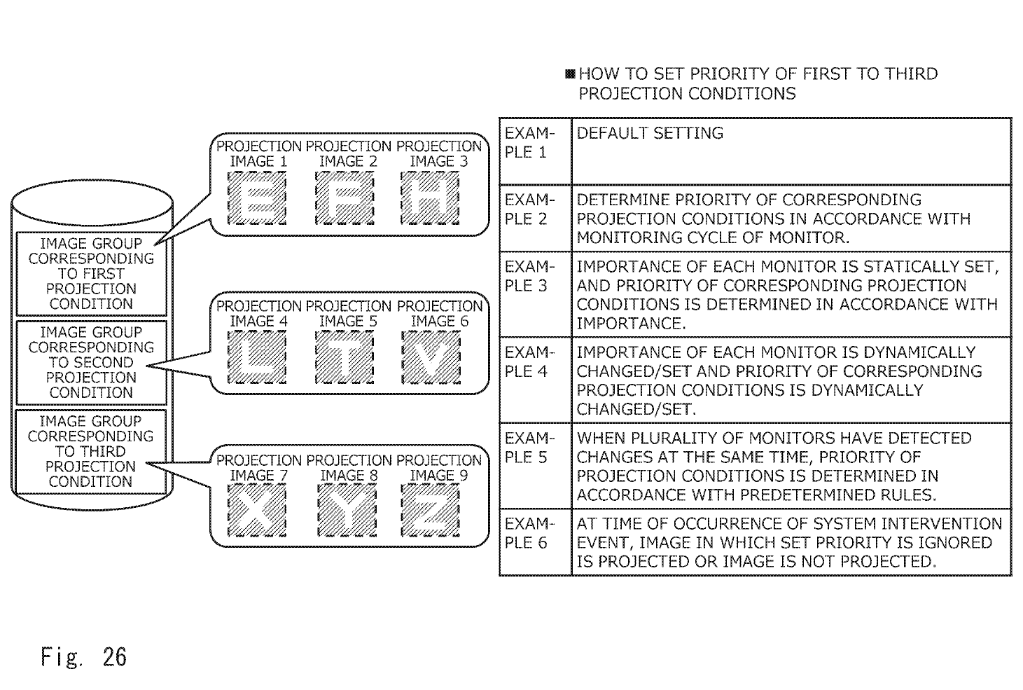

Next, with reference to FIG. 26, a specific example of setting of priority of projection conditions will be described. In the example shown in FIG. 26, a projection condition evaluated based on the first monitoring information of the first monitor 401 is referred to as a first projection condition, a projection condition evaluated based on the second monitoring information of the second monitor 402 is referred to as a second projection condition, and a projection condition evaluated based on the third monitoring information of the third monitor 403 is referred to as a third projection condition. Further, an image group corresponding to the first projection condition includes a "projection image 1", a "projection image 2", and a "projection image 3", an image group corresponding to the second projection condition includes a "projection image 4", a "projection image 5", and a "projection image 6, and an image group corresponding to the third projection condition includes a "projection image 7", a "projection image 8", and a "projection image 9".

In "Example 1" shown in FIG. 26, the priority of projection conditions is set to a default priority. The default priority is, for example, an order of the first projection condition, the second projection condition, and the third projection condition. In this case, if the projection condition for the projection image 1, which is the image corresponding to the first projection condition, is satisfied and the projection condition for the projection image 4, which is the image corresponding to the second projection condition, is also satisfied, the projection image 1 corresponding to the first projection condition is projected according to the priority. When all the images corresponding to the first projection condition do not satisfy the projection condition and the projection condition for the projection image 4, which is the image corresponding to the second projection condition, and the projection condition for the projection image 7, which is the image corresponding to the third projection condition, have been satisfied, the projection image 4 is projected according to the priority.

In "Example 2", the priority of projection conditions is determined in accordance with the monitoring cycle of the corresponding monitor. For example, the shorter the monitoring cycle of the monitor, the higher the priority of the corresponding projection condition. On the other hand, the longer the monitoring cycle of the monitor, the lower the priority of the projection condition. This is because it is preferable to set, for a shorter monitoring cycle of the monitor, the priority of projection conditions to be higher since a shorter monitoring cycle of the monitor means more important information.

In "Example 3", the importance of each monitor is statically set in the monitor in advance, and the priority of projection conditions is determined in accordance with the importance of the corresponding monitor. When, for example, the user has set the importance of the monitors in such a way that the second monitor 402 > the third monitor 403 > the first monitor 401 by operating the screen displayed on the mobile terminal 26, the priority of projection conditions is set in such a way that the second projection condition > the third projection condition > the first projection condition.

In "Example 4", the priority of projection conditions is dynamically changed or set in accordance with the importance of the monitor that has been dynamically changed or set. When, for example, the first monitor 401 monitors the user's driving operation and the first monitor has detected the user's driving operation, the priority of the first projection condition corresponding to the first monitor 401 is set to be high (e.g., the priority becomes higher after the user's driving operation is detected than the priority before it is detected). Further, when the second monitor 402 monitors a change in the external environment and the second monitor has detected a change in the external environment, the priority of the second projection condition corresponding to the second monitor 402 is set to be high. Further, when the third monitor 403 monitors a change in vehicle information and the third monitor has detected a change in the vehicle information, the priority of the third projection condition corresponding to the third monitor 403 is set to be high.

In "Example 5", the priority of projection conditions is determined in accordance with predetermined rules when a plurality of monitors have detected changes substantially at the same time. When, for example, the projection image 1 corresponding to the first projection condition starts to be projected and this image is projected for five seconds, a plurality of monitors may detect changes during the five seconds. Specifically, assume a case in which the second monitor has detected a change two seconds after the projection image 1 starts to be projected and the projection condition for the projection image 4 corresponding to the second projection condition is satisfied, and the third monitor has detected a change four seconds after the projection image 1 starts to be projected and the projection condition for the projection image 7 corresponding to the third projection condition is satisfied. In this case, after finishing projecting the first projection image for five seconds, a high priority is given to, for example, the projection condition corresponding to the monitor that has detected a change first, as one example. That is, since the priority of the second projection condition corresponding to the second monitor that has detected the change after two seconds is made higher, the priority is set in such a way that the projection image 4 > the projection image 7. As a modification example, the priority of the projection condition corresponding to the monitor that has detected the change at a later timing is made high. That is, since the priority of projection condition corresponding to the third monitor that has detected the change after four seconds is made higher, the priority is set in such a way that the projection image 7 > the projection image 4. As a modification example, the priority of the projection condition that is predetermined to have a high priority in default setting or the like is made high. That is, when the priority in the default setting is set in such a way that the projection condition 1 > the projection condition 2 > the projection condition 3, the priority is set in such a way that the projection image 4 > the projection image 7.

In "Example 6", in a case of emergency, such as when an abnormality has occurred in the vehicle or the external environment (at the time of occurrence of a system intervention event), an image is projected by ignoring the set priority of evaluation conditions or an image is not projected. When, for example, a warning function for the user is activated, an image for alerting the user is projected by ignoring the priority of projection conditions. In other words, the priority of the image displaying the warning is temporarily set to the highest level. Further, when an emergency stop function is activated, even when a projection condition has been satisfied, the corresponding image is not projected.

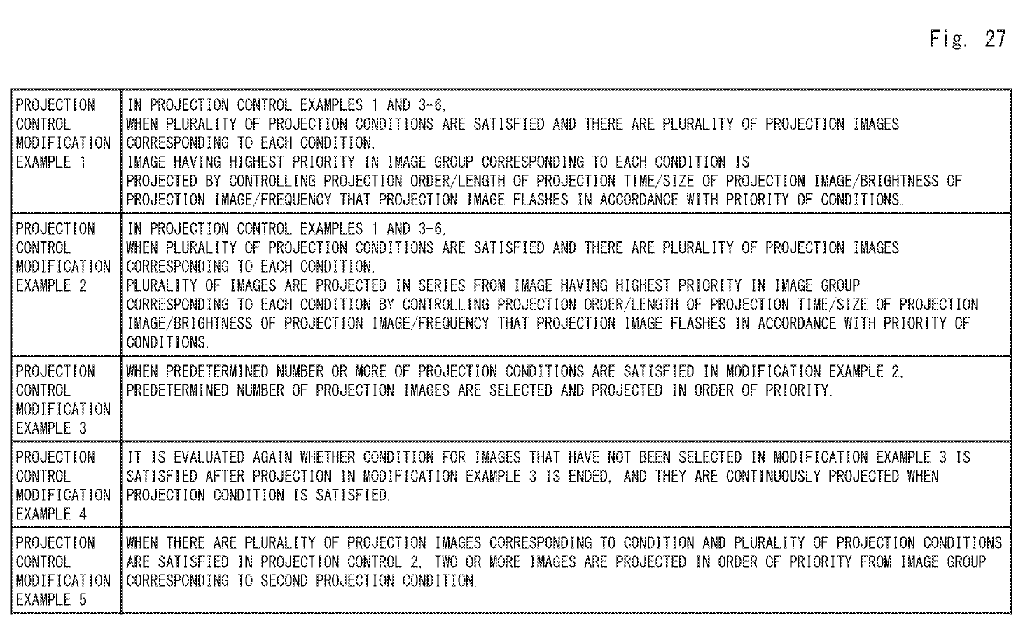

Next, with reference to FIG. 27, a specific example of evaluation of the priority of the projection images in a case where priority of projection conditions is set will be described. In the example shown in FIG. 27, like in FIG. 26, the first monitor 401 to the third monitor 403 correspond to the first to third projection conditions, and an image group corresponding to the first projection condition includes a projection image 1, a projection image 2, and a projection image 3, an image group corresponding to the second projection condition includes a projection image 4, a projection image 5, and a projection image 6, and an image group corresponding to the third projection condition includes a projection image 7, a projection image 8, and a projection image 9. Then, in the example shown in FIG. 27, the priority of projection conditions is an order of the second projection condition > the third projection condition > the first projection condition. Further, in the image group corresponding to the first projection condition, the priority of the projection images is an order of the projection image 1 > the projection image 2 > the projection image 3. Further, in the image group corresponding to the second projection condition, the priority of the projection images is an order of the projection image 4 > the projection image 5 > the projection image 6. Further, in the image group corresponding to the third projection condition, the priority of the projection images is an order of the projection image 7 > the projection image 8 > the projection image 9.

In a "projection control modification example 1" shown in FIG. 27, when a plurality of projection conditions (a first projection condition to a third projection condition) are satisfied, the projection order/the length of the projection time/the size of the projection image/the brightness of the projection image/the frequency that the projection image flashes are controlled in the order of the image having the highest priority in the image group corresponding to the second projection condition, the image having the highest priority in the image group corresponding to the third projection condition, and the image having the highest priority in the image group corresponding to the first projection condition. Specifically, the projection order/the length of the projection time/the size of the projection image/the brightness of the projection image/the frequency that the projection image flashes are controlled in the order of, for example, the projection image 4 having the highest priority in the image group corresponding to the second projection condition, the projection image 7 whose priority is the highest in the image group corresponding to the third projection condition, and the projection image 1 whose priority is the highest in the image group corresponding to the first projection condition among the images for which the projection condition is satisfied. Specifically, projection control in accordance with the priority is performed in such a way that the higher the above priority, the sooner the image is projected, the longer the projection time, the brighter the projection image, and the higher the frequency that the projection image flashes.

In a "projection control modification example 2", when a plurality of projection conditions (the first projection condition to the third projection condition) are satisfied, the projection order/the length of the projection time/the size of the projection image/the brightness of the projection image/the frequency that the projection image flashes are controlled in the order of a plurality of images in series from the image having the highest priority in the image group corresponding to the second projection condition, a plurality of images in series from the image having the highest priority in the image group corresponding to the third projection condition, and a plurality of images in series from the image having the highest priority in the image group corresponding to the first projection condition. Specifically, the projection order/the length of the projection time/the size of the projection image/the brightness of the projection image/the frequency that the projection image flashes are controlled in the order of, for example, among the images for which the projection condition is satisfied, the projection image 4 whose priority is the highest in the image group corresponding to the second projection condition, the projection image 7 whose priority is the highest in the image group corresponding to the third projection condition, next the projection image 1 whose priority is the highest in the image group corresponding to the first projection condition, the projection image 5 whose priority is the second highest in the above image group corresponding to the second projection condition, the projection image 8 having the second highest priority in the image group corresponding to the third projection condition, and the projection image 2 having the second highest priority in the image group corresponding to the first projection condition.

In a "projection control modification example 3", a predetermined number of projection images are selected and projected in the order of priority in the "projection control modification example 2". Specifically, in an example in which the predetermined number is 3, the projection image 4 whose priority is the highest in the image group corresponding to the second projection condition, the projection image 7 whose priority is the highest in the image group corresponding to the third projection condition, and the projection image 1 whose priority is the highest in the image group corresponding to the first projection condition are selected among the images for which the projection condition has been satisfied, and the images are projected in this order. The images (e.g., the projection image 5, the projection image 8, the projection image 2) with second or lower priority in the image group corresponding to each projection condition among the images for which the projection condition has been satisfied are not selected in this example since the number of projection images exceeds the upper limit of the predetermined number.

In a "projection control modification example 4", it is evaluated whether the projection condition for the projection images that have not been selected in the "projection control modification example 3" is satisfied again after projection of the selected projection images is ended, and they are projected when the projection condition is satisfied. Specifically, for example, after projection of the projection image 4, the projection image 7, and the projection image 1 is ended, it is evaluated whether or not the projection condition is satisfied for the projection image 5, the projection image 8, and the projection image 2, and the image whose priority is the highest (e.g., the projection image 5) among the images for which the projection condition is satisfied is projected. After the projection image 5 is projected for a predetermined period of time, evaluation similar to the one stated above is performed. When the projection condition is satisfied, for example, the projection image 8 may be projected next. As another modification example of the projection control modification example 4, it may be evaluated whether or not images other than those selected in the projection control modification example 3 satisfy the projection condition after projection of the selected projection image is ended, and the images may be projected if the projection condition is satisfied. That is, when projection of one image is ended and the next projection image is determined, it may be evaluated whether or not all the images including projection images for which the projection condition has been satisfied in the previous evaluation satisfy the projection condition, and one of the images for which the projection condition has been satisfied at this point which has the highest priority may be projected. Further, at this time, the priority of the projection image for which the projection condition has been satisfied in the previous evaluation may be set high.

In a "projection control modification example 5", when a plurality of projection conditions (the first projection condition to the third projection condition) are satisfied, a plurality of (e.g., two or more) images are sequentially projected in the order of priority from the image group corresponding to the projection condition having the highest priority. Specifically, projection images for which the projection condition is satisfied are projected in the order of priority among the projection images in the image group corresponding to the second projection condition having the highest priority. For example, the projection image 4 is projected first and the projection image 5 is projected next. Then, the projection image 6 may be further projected.

Further, by using the technique according to the aforementioned embodiments, it is possible to appropriately display necessary information such as an image for a driver and an image for persons who are present near the vehicle. Accordingly, it is possible to provide an information projection apparatus that contributes to safe driving, etc. In accordance therewith, it is possible to reduce traffic accidents. It is further possible to contribute to "3. Good-Health and Well-Being" of Sustainable Development Goals (SDGs) advocated by the United Nations.

The first to ninth embodiments can be combined as desirable by one of ordinary skill in the art.)

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An information projection apparatus comprising:
a receiver configured to acquire information on a vehicle;
an image projector configured to project an image based on the information acquired by the receiver; and
a control unit configured to control projection of the image,
wherein the control unit projects an image evaluated by a preset projection condition in accordance with priority based on the information.

2. The information projection apparatus according to claim 1, wherein
when the control unit starts projecting a projection image in accordance with the priority, the control unit starts measuring a projection time of the projection image, performs evaluation of priority of an image to be projected next to the image that is being projected by a preset projection condition while the projection image is being projected, and ends the projection of the projection image after a projection time of the projection image reaches a preset projection duration time by the measurement.

3. The information projection apparatus according to claim 2, wherein, when there is an image for which a condition has been satisfied among projection conditions that change in real time at a time when the projection of the projection image is ended, the control unit performs projection in accordance with priority of the image evaluated by a preset projection condition.

4. The information projection apparatus according to claim 3, wherein, after the projection of the projection image is ended, the control unit starts measuring an interval time, and projects the image after a predetermined interval time has passed.

5. The information projection apparatus according to claim 2, wherein, when there is no image for which a projection condition is satisfied at a time when the projection of the projection image is ended, the control unit repeatedly performs evaluation of priority of images by a preset projection condition, and projects an image for which the projection condition is satisfied.

6. The information projection apparatus according to claim 2, wherein, when a projection condition for an image for alerting emergency is satisfied, the control unit ends the projection of the image that is being projected even before the projection duration time elapses, and projects an image for alerting the emergency.

7. The information projection apparatus according to claim 1, wherein the control unit performs evaluation of a projection order of images by a preset projection condition at each predetermined cycle.

8. The information projection apparatus according to claim 1, further comprising a communication,
wherein the control unit communicates with information equipment via the communication, acquires information on a projection image from the information equipment, and determines, based on the acquired information on the projection image, a projection image to be projected.

9. The information projection apparatus according to claim 8, wherein the control unit acquires information regarding a projection order of projection images from the information equipment, and sets a projection order of the projection images based on the acquired information regarding the projection order of the projection images.

10. The information projection apparatus according to claim 1, wherein the control unit comprises:
a condition evaluator configured to evaluate a projection condition for projecting the projection image;
a priority controller configured to set priority of a plurality of projection conditions; and
an evaluation result sorter configured to evaluate the priority of the projection conditions based on an evaluation result by the condition evaluator and the priority set by the priority controller.

11. The information projection apparatus according to claim 10, wherein the control unit further comprises a pattern generator configured to generate, based on predetermined pattern setting information, a projection pattern of the projection image projected based on the priority determined by the evaluation result sorter.

12. The information projection apparatus according to claim 10, wherein
the priority controller comprises:
a priority evaluator configured to evaluate the priority based on predetermined setting information; and
a priority updater configured to update, based on predetermined update information, the priority evaluated by the priority evaluator.

13. The information projection apparatus according to claim 10, wherein
the control unit further comprises a factor analysis unit configured to analyze, based on weight setting information regarding a degree of weight to be added to a factor that satisfies the projection condition, a weight added to the factor, and
the evaluation result sorter changes the determined priority of the projection conditions based on a result of analyzing the weight added to the factor analyzed by the factor analysis unit.
